(19) United States
(12) Patent Application Publication
(10) Pub. No.: US 2017/0324554 A1
(43) Pub. Date: Nov. 9, 2017

(54) Public Key Cryptosystem Based On Partitioning Of Galois Field Elements

(71) Applicant: PQ Solutions Limited, London (GB)

(72) Inventors: Martin Tomlinson, Totnes (GB); Cen Jung Tjhai, London (GB)

(21) Appl. No.: 15/587,910

(22) Filed: May 5, 2017

(30) Foreign Application Priority Data
May 5, 2016 (GB) 1607908.9

(51) Int. Cl. H04L 9/08; H04L 9/30; H04L 9/06; H04L 29/06; H04L 9/14; G06F 7/72

(52) U.S. Cl. CPC H04L 9/0861; H04L 63/0428; H04L 9/3093; H04L 9/14; H04L 9/0852; H04L 9/0618; G06F 7/727

(57) ABSTRACT

A post-quantum, public key cryptosystem is described which is polynomial based and where the private key polynomial has coefficients from a sub-set of Galois field elements and plain text message polynomials have coefficients from a second sub-set of Galois field elements. The public key polynomial is constructed using the inverse of the private key polynomial and a randomly chosen polynomial having coefficients chosen from a third sub-set of Galois field elements. Cipher texts are constructed using the public key and randomly chosen session key polynomials. Other more complicated embodiments are described. For implementation a small prime base field such as 2, 3 or 5 will usually be used in constructing the prime power Galois field. The system has the advantage of relatively small public key sizes.

### FIELD OF INVENTION

The present invention relates to encoding and decoding of information and, more particularly, to a public key cryptosystem for encryption and decryption of digital messages by computer systems.

### BACKGROUND

There are a number of different public key cryptosystems that have been proposed some of which are in widespread use in practical applications. They are all based on the extreme difficulty of performing a computation in reverse without the knowledge of some secret information whilst the computation in the forward direction is straightforward. There is a public key used for encryption which is of no use for decryption which can only be done by using a secret, private key.

Public key encryption is an invaluable technology enabling information to be encrypted and securely sent from one person to another without the need for a secret key to be shared ahead of time between the parties. The first method was secretly invented in 1973 by Ellis, Cocks and Williamson whilst working at GCHQ and was based on the difficulty of finding discrete logarithms. Their method was independently invented by Diffie and Hellman who published their Diffie-Hellman key exchange in 1976.

Another method was independently invented in 1978 by Rivest, Shamir and Adleman, based on the considerable difficulty of factorising large integers into prime factors. It is known as RSA and is in widespread use today. Since then other methods have been invented such as ElGamal and Elliptic Curve Cryptography (ECC).

Another different public key system is the McEliece system invented by the distinguished mathematician Robert McEliece in 1978. It is the first example of code based cryptography and uses the family of binary Goppa error correcting codes. The McEliece method relies on the difficulty of correcting unknown random errors if the particular Goppa code used in generating the public and private keys is unknown. A plaintext message is encoded into binary codewords using the public key and a randomly chosen error pattern containing up tot bits is added to each codeword to produce the ciphertext. In decryption the associated private key is used to deploy an error correcting decoder based upon the underlying Goppa code to correct the errored bits in each codeword, prior to retrieval of the plaintext message.

A further different public key system is described in U.S. Pat. No. 6,081,597 to Hoffstein, Pipher and Silverman. The described system uses polynomial algebra based on circulants and a modulo arithmetic based on two numbers p and q. Successful decryption is probabilistic, not certain, although the risk of failure can be made negligible by suitable choice of parameters.

### SUMMARY OF THE INVENTION

Aspects of the present invention are set out in the accompanying claims, advantageously providing a secure cryptosystem implementing relatively small public key sizes.

According to one aspect, the present invention provides a method of encrypting a digital message, the method comprising:

(a) generating a private key polynomial having coefficients from a first sub-set of predefined Galois field elements;

(b) constructing an inverse private key polynomial having coefficients which are an inverse of said private key polynomial where the polynomial product of the private key polynomial and the inverse private key polynomial modulo a third polynomial F(x) is equal to 1;

(c) generating a polynomial B(x) having coefficients from a second sub-set of said Galois field elements;

(d) constructing a public key polynomial by multiplying the inverse private key polynomial by the polynomial B(x) modulo F(x);

(e) representing the digital message as a polynomial M(x) having coefficients from a third sub-set of said Galois field elements;

(f) generating a session key polynomial S(x) having coefficients from a fourth sub-set of said Galois field elements; and

(g) generating an encrypted message by multiplying the session key polynomial S(x) by the public key polynomial, modulo F(x), and adding the result to the message polynomial M(x) to produce a polynomial representation of a cipher text.

According to another aspect, the present invention provides a method of encrypting a digital message, the method comprising:

(a) generating a private key polynomial having coefficients from a first sub-set of predefined Galois field elements;

(b) constructing an inverse private key polynomial having coefficients which are an inverse of said private key polynomial where the polynomial product of the private key polynomial and the inverse private key polynomial modulo a third polynomial F(x) is equal to 1

(c) generating a polynomial B₁(x) having coefficients from a second sub-set of said Galois field elements;

(d) generating a polynomial B₂(x) having coefficients from a third sub-set of said Galois field elements;

(e) generating a polynomial R₁(x) having coefficients from a fourth sub-set of said Galois field elements;

(f) generating a polynomial R₂(x) having coefficients from a fifth sub-set of said Galois field elements;

(g) constructing a public key polynomial by multiplying the inverse private key polynomial by the sum of the polynomial B₁(x) and R₁(x), modulo F(x), and then adding the polynomials B₂(x) and R₂(x);

(h) representing the digital message as a polynomial M(x) having coefficients from a sixth sub-set of said Galois field elements;

(i) generating a session key polynomial S(x) having coefficients from a seventh sub-set of said Galois field elements; and

(j) generating an encrypted message by multiplying the session key polynomial S(x) by the public key polynomial, modulo a polynomial F(x), and adding the result to the message polynomial M(x) to produce a polynomial representation of a cipher text.

In a further aspect, there is provided a post-quantum, public key cryptosystem which is polynomial based and where the private key polynomial has coefficients from a sub-set of Galois field elements and plain text message polynomials have coefficients from a second sub-set of Galois field elements. The public key polynomial is constructed using the inverse of the private key polynomial and a randomly chosen polynomial having coefficients chosen from a third sub-set of Galois field elements. Cipher texts are constructed using the public key and randomly chosen session key polynomials. For implementation a small prime base field such as 2, 3 or 5 may be used in constructing the prime power Galois field.

In other aspects, there are provided apparatus and systems configured to perform the methods as described above. In a further aspect, there is provided a computer program comprising machine readable instructions arranged to cause a programmable device to carry out any one of the methods as described above.

### BRIEF DESCRIPTION OF THE DRAWINGS

There now follows, by way of example only, a detailed description of embodiments of the present invention, with references to the figures identified below.

FIG. 1 is a block flow diagram showing the main components of a system according to an exemplary embodiment of the invention.

FIG. 2 is a functional block flow diagram illustrating the generation of public and private keys by a key generator according to the exemplary embodiment.

FIG. 3 is a functional block flow diagram illustrating the generation of cipher text by a corresponding encoder for a given message using the generated public key, according to the exemplary embodiment.

FIG. 4 is a functional block flow diagram illustrating the decryption of cipher text by a complementary decoder using the generated private key, according to the exemplary embodiment.

FIG. 5 is a functional block flow diagram illustrating the reconstruction of a session key by a corresponding session key reconstructor, according to the exemplary embodiment.

FIG. 6 is a functional block flow diagram illustrating the construction of a message hash using a keyed hash function whose key is a session key constructed by a complementary session key constructor, according to the exemplary embodiment.

FIG. 7 is a functional block flow diagram illustrating the verification of received data by a data verifier, according to the exemplary embodiment.

FIG. 8 is a functional block diagram illustrating the generation of public and private keys by a key generator according to an alternative embodiment.

FIG. 9 is a functional block flow diagram illustrating the generation of cipher text by a corresponding encoder according to the alternative embodiment.

FIG. 10 is a functional block flow diagram illustrating a complementary decoder module according to the alternative embodiment.

FIG. 11 is a functional block flow diagram illustrating the generation of a public and private keys by a key generator according to a further embodiment.

FIG. 12 is a functional block flow diagram illustrating the construction of a translation polynomial for reconstruction of a session key, according to the further embodiment.

FIG. 13 is a functional block flow diagram illustrating the reconstruction of a session key by a corresponding session key reconstructor, according to the further embodiment.

FIG. 14 is a functional block flow diagram illustrating the decryption of cipher text by a complementary decoder, according to the further embodiment.

FIG. 15 is a functional block diagram illustrating the generation of public and private keys by a key generator according to another alternative embodiment.

FIG. 16 is a functional block flow diagram illustrating the generation of cipher text by a corresponding encoder according to the alternative embodiment.

FIG. 17 is a functional block flow diagram illustrating a complementary decoder module according to the alternative embodiment.

FIG. 18 is a functional block flow diagram illustrating a decoder module according to yet a further alternative embodiment.

FIG. 19 is a diagram of an example of a computer system on which one or more of the functions of the described embodiments may be implemented.

### DETAILED DESCRIPTION

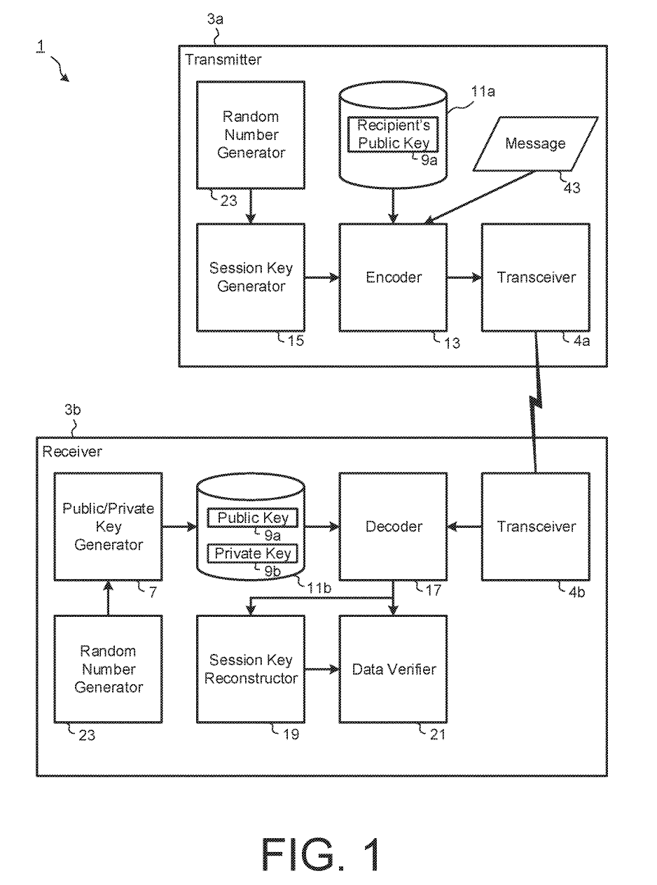

FIG. 1 is a block flow diagram schematically showing the main components of a system 1 according to an exemplary embodiment. As shown, the system 1 includes first device 3a in communication with a second computing devices 3b, referred to herein as a transmitter device 3a and a receiver device 3b respectively, via respective transceiver interfaces 4a,b for example over a data network 5. The interfaces 4 may include computer executable instructions for the respective computing devices 3 to establish and transmit data over a transmission path therebetween, such as encrypted data generated by the transmitter device 3a using a public key 9a associated with the recipient device 3b.

The system 1 comprises a public and private key pair generator 7, for example as a processing module of the receiver device 3b, that generates the recipient's public key 9a and a corresponding private key 9b, based on polynomial algebra modulo a predefined number or function. The recipient's public key 9a may be shared publicly, for example communicated to the transmitter device 3a via the data network 5, and stored in a memory 11a of the transmitter device 3a. The generated cryptography keys 9 may also be stored in a memory 11b of the associated receiver device 3b. The transmitter device 3a also comprises an encoder (encryption) module 13 configured to encode (encrypt) input plaintext into cipher text, using the generated public key 9a and a session key output by a session key generator 15 of the transmitter device. The session key may be generated 3a by the session key generator 15 each time the encoder 13 is used to encrypt an input data message M(x) 43.

The recipient device 3b comprises a complementary decoder (decryption) module 17 configured to decode (decrypt) cipher text that was encrypted using the generated public key 9a, into plaintext using the corresponding private key 9a. In this embodiment, output from the decoder module 17 is passed to a session key reconstructor module 19 that reconstructs a session key from the decrypted plaintext, using polynomial algebra modulo the predefined number or function. The decrypted plaintext and the reconstructed session key may be passed to a data verifier module 21 for additional data processing to verify, for example, that the reconstructed session key contains embedded data elements that correspond to data elements in and/or derived from the decrypted plaintext.

Respective random number generator modules 17 may also be provided in the devices 3, to generate and provide random numbers to the key generator modules 7,15 and encoder module 13, as will be described in more detail below.

The devices 3 may be of a type that is known per se, such as a desktop computer, laptop computer, a tablet computer, a smartphone such as an iOS®, Blackberry® or Android® based smartphone, a ‘feature’ phone, a personal digital assistant (PDA), or any processor-powered device with suitable input and output means. The data network 7 may comprise a terrestrial cellular network such as a 2G, 3G, 4G or 5G network, a private or public wireless network such as a WiFi®-based network and/or a mobile satellite network or the Internet. It is appreciated that a plurality of computing devices 3 may be operable concurrently within the system 1, as transmitters and/or recipients of data therebetween. Although not illustrated, the devices 3 would typically also include the complementary data processing modules to generate, send, receive and process received data as described in the present embodiments.

As will be described in greater detail below, the encryption technique of the described embodiments is based on polynomial algebra involving constrained polynomial coefficients from a Galois field, modulo a predefined fixed polynomial F(x), while the decryption technique is based on the complementary polynomial algebra whose validity depends on elementary Galois field theory. As is known in the art, the polynomial is a convenient representation of ordered coefficients, and as will be described in detail below, the processing modules of the system 1 are configured to perform designated operations on coefficients of respective constructed polynomials. Advantageously, the security of the public key cryptosystem is provided by the interaction of the polynomial computation system with the dependence on polynomials whose coefficients are from constrained sub-sets of a Galois field. Security also relies on the known fact that for most lattices, it is very difficult to find the shortest vector if there are a large number of vectors which are only moderately longer than the shortest vector.

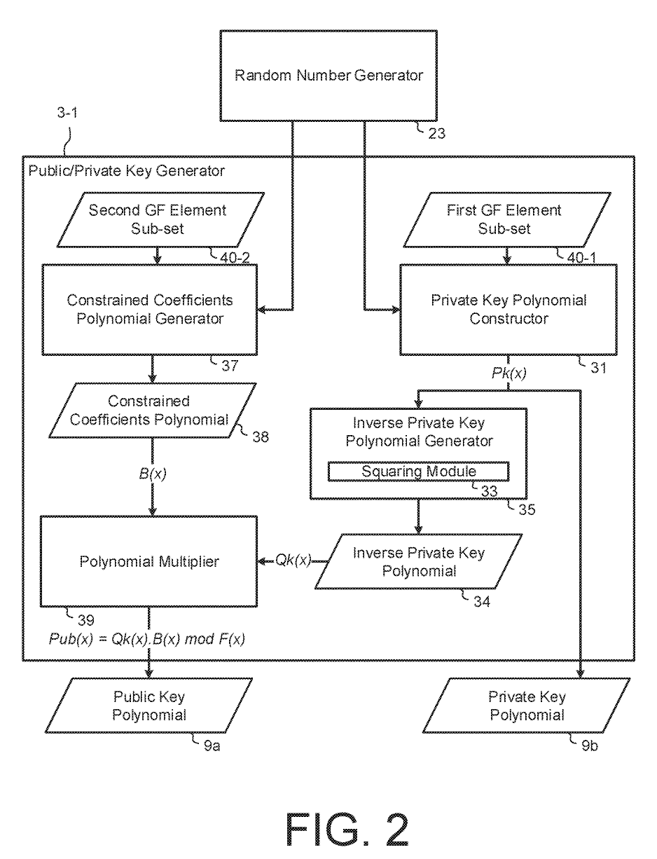

FIG. 2 shows a block flow diagram for the generation of public and private keys 9 by a key generator 3-1 according to one exemplary embodiment. Embodiments of the present invention utilise the structure of predefined Galois fields (GF) which are a power of a base field and the partitioning of field elements into defined sub-sets of elements. The base field is a prime number, typically 2, which, being binary, has practical advantages but any prime number based system may be used. Considering a simple example for illustration purposes, the arithmetic modules in this embodiment process symbols having values taken from a small Galois field size of 16, (2⁴). The system is described using an example with short public and private keys of length N=14 symbols.

In practice for cryptographic security, much larger field sizes and longer key lengths, several hundred symbols long would be used. For example, a secure system may use a GF of size 2⁸=256 (suitable for symbol alphabet, such as ANSI, ASCII or Unicode characters sets) or 2¹⁶=65536 (suitable for larger symbol alphabets).

A private key polynomial constructor 31 of the key generator 3-1 receives an input sequence of random data, such as a random sequence of binary 0's and 1's, from the random number generator 23. The private key polynomial constructor 31 generates a private key 9b consisting of a sequence of random coefficients selected from the input random sequence, provided these coefficients are from a sub-set of the Galois field. In the present worked example, the generated private key 9b consists of coefficients whose value is from a defined first sub-set 40-1 of the Galois field, consisting in this worked example, the GF(16) elements: 0100, 0110, 0010 and 0000. Coefficients are selected from the input random sequence until there are a total of N randomly chosen coefficients from the first sub-set 40-1 of the Galois field. In this worked example, N=14 and the private key has 14 coefficients.

To simplify decryption, the first coefficient of the randomly chosen private key may have 1000 added modulo 2. An example of such a private key polynomial has the following sequence of coefficient values:

1000 0000 0010 0000 0100 0010 0110 0110 0010 0010 0110 0000 0000 0010

In this example, the symbols correspond to symbols from a Galois field of GF(2⁴) generated by the primitive generator polynomial: 1+x+x⁴. With α denoting a primitive root, all of the symbols from this field may be mapped as a power of a together with their representation in binary and as a decimal number. These symbols are tabulated below:

TABLE 1
Representations of GF(2⁴)

| | | Decimal |
|---|---|---|
| Value | Power | representation |
| 1000 | α⁰ | 1 |
| 1001 | α¹ | 9 |
| 1011 | α² | 13 |
| 1111 | α³ | 15 |
| 0111 | α⁴ | 14 |
| 1110 | α⁵ | 7 |
| 0101 | α⁶ | 10 |
| 1010 | α⁷ | 5 |
| 1101 | α⁸ | 11 |
| 0011 | α⁹ | 12 |
| 0110 | α¹⁰ | 6 |
| 1100 | α¹¹ | 3 |
| 0001 | α¹² | 8 |
| 0010 | α¹³ | 4 |
| 0100 | α¹⁴ | 2 |
| 0000 | 0 | 0 |

Based on the predefined mapping of Table 1, the exemplary private key 5b above may be represented in decimal numbers as:
1 0 4 0 2 4 6 6 4 4 6 0 0 4

The same exemplary sequence may be represented as a polynomial (with zero value coefficients omitted):

Pk(x)=1+α¹³x²+α¹⁴x⁴+α¹³x⁵+α¹⁰x⁶+α¹⁰x⁷+α¹³x⁸+α¹³x⁹+α¹⁰x¹⁰+α¹³x¹³

In the described embodiments, the inverse polynomial Qk(x) to the private key polynomial Pk(x) is calculated by the key generator 3. This may be done in several ways. In the present embodiment, a squaring module 33 of an inverse private key polynomial generator 35 as shown in FIG. 2 generates the inverse of Pk(x) 34 by considering Pk(x) as an element of the Galois field GF(2^{4.N}), where N is the sequence length. In the present simplified example N is 14, i.e. GF(2^{4.14})=GF(2⁵⁶) for example by using an irreducible polynomial of the form 1+α⁻⁵x+x^{N}, where s is a small integer such as 1 or 2 in this example using a small field size GF(2⁴). Larger integer values of s, such as 3 or 4, may be used when coefficients are from larger fields, such as GF(2¹⁶). The irreducible polynomial F(x)=1+α⁵x+x^{N} may also turn out to be a primitive polynomial depending on the values of s (e.g. s=−3 or −4) and N.

To compute the inverse of Pk(x) 34, it is noted for some integer w that, [Pk(x)]^{w}=Pk(x) modulo 1+α⁻⁵x+x^{N} where w=2^{r}.

For the present worked example, [Pk(x)]^{w}=Pk(x) modulo 1+α⁻¹x+x¹⁴ where w=239.

Accordingly, the squaring module 33 computes the square of Pk(x) modulo 1+α^{-l}x+x¹⁴ and repeatedly squares the result until the result is equal to Pk(x). It follows that the inverse of Pk(x) 34 as computed by the inverse private key polynomial generator 35 can be represented as:

Qk(x)=[Pk(X)]^{w-2}.

It should be noted that 2^{r}−2=2^{r-1}+2^{r-2}+2^{r-3}+2^{r-4}+2^{r-5} . . . +4+2

For the present worked example, 2³⁹−2=2³⁸+2³⁷+2³⁶+4+2

In this embodiment, the squaring module 33 obtains the inverse Qk(x) 34 by multiplying [Pk(x)]² by [Pk(x)]⁴ and by [Pk(x)]⁸ then by [Pk(x)]¹⁶ and so on up to power 2³⁸.

Accordingly, following from the present worked example, the inverse private key polynomial generator 35 computes the inverse private key polynomial as:

Qk(x)=α¹³+α¹⁰x+α⁵x²+α⁶x³+α¹²x⁴+α⁸x⁵+α°x⁶+α¹³x⁷+α³x⁸+α⁹x⁹+α¹x¹⁰+α⁷x¹¹+α⁶x¹²+α³x¹³

or with the coefficients represented as decimal numbers using the predefined mapping of Table 1, the sequence:
4 6 7 10 8 11 1 4 15 12 9 5 10 15

It can be verified by polynomial multiplication, for example based on GF(16) arithmetic with reference to Table 1, that:

Pk(x)·Qk(x)=1 modulo 1+α⁻¹x+x¹⁴

It should be noted that whilst Pk(x) has restricted coefficients from a sub-set of the Galois field listed in Table 1, Qk(x) has coefficients which can take any value of the Galois field. The above worked example may be represented in generalised form so there is a Qk(x) that is the inverse of Pk(x) such that

Pk(x)·Qk(x)=1 modulo F(x)

where F(x) may be an irreducible polynomial or reducible polynomial, such as a circulant polynomial of the type 1+x^{N}. Circulant polynomials are used in further embodiments described below. For cases where F(x) is reducible, some particular examples of Pk(x) may have common factors with F(x) and therefore Qk(x) does not exist. If this happens, another example for Pk(x) can be selected for which Qk(x) does exist.

Other methods of determining the inverse polynomial Qk(x) from Pk(x) may be used by the inverse private key polynomial generator 35 instead of the squaring technique as implemented by the squaring module 25, such as Gaussian elimination or the extended Euclidean algorithm. The generated inverse private key polynomial Qk(x) 34 may be stored together with the associated public and private key pair polynomials 9a,9b in the memory 11b of the receiver 3b.

As shown in FIG. 2, the output of the random number generator 23 is also input to a constrained coefficients polynomial generator module 37 that generates a corresponding random sequence of symbols selected from a constrained sub-set of the Galois field elements or symbols for an output polynomial B(x) 38, defining a derivable factor for the generation of a public key polynomial. In one example, the constrained coefficients polynomial generator module 37 performs data processing to select from the input sequence of random 1's and 0's so as to choose the coefficients of the output polynomial B(x) 38 so that these are from a pre-determined sub-set of the Galois field listed in Table 1. In the present worked example, the constrained coefficients of B(x) consists of two symbols, 0100 and 0000, corresponding to selected random bit values received from the random number generator 23. Other coefficient constraints so as to choose coefficients from alternative sub-sets of the Galois field may be used as described in alternative embodiments below. An exemplary sequence of decimal numbers for the constrained coefficients of B(x) 38, using the mapping from Table 1, is:
2 0 2 2 2 0 0 0 0 2 2 0 2 0

Equivalently, B(x)=α¹⁴+α¹⁴x²+α¹⁴x³+α¹⁴x⁴+α¹⁴x⁹+α¹⁴x¹⁰+α¹⁴x¹²

A polynomial multiplier 39 receives the polynomial B(x) 38 output by the constrained coefficients polynomial generator module 37 with the inverse private key polynomial Qk(x) output by the inverse private key polynomial generator 35, and produces the public key Pub(x) by multiplying together Qk(x) and B(x) using Galois field arithmetic for the resulting polynomial coefficients, modulo a defined polynomial F(x). In the present worked example, F(x) is an irreducible polynomial, 1+αx+x¹⁴

Pub(x)=Qk(x)·B(x)modulo 1+α⁻¹x+x¹⁴

Following from the present worked example, the result output by the polynomial multiplier 39 is the public key polynomial:

Pub(x)=α⁹+α¹³x+α⁷x²+α¹²x³+α¹³x⁴+α⁶x⁵+α⁶x⁶+α¹¹x⁷+α⁴x⁸+α⁴x⁹+α⁸x¹⁰+α⁷x¹¹+α¹²x¹²+α⁷x¹⁴

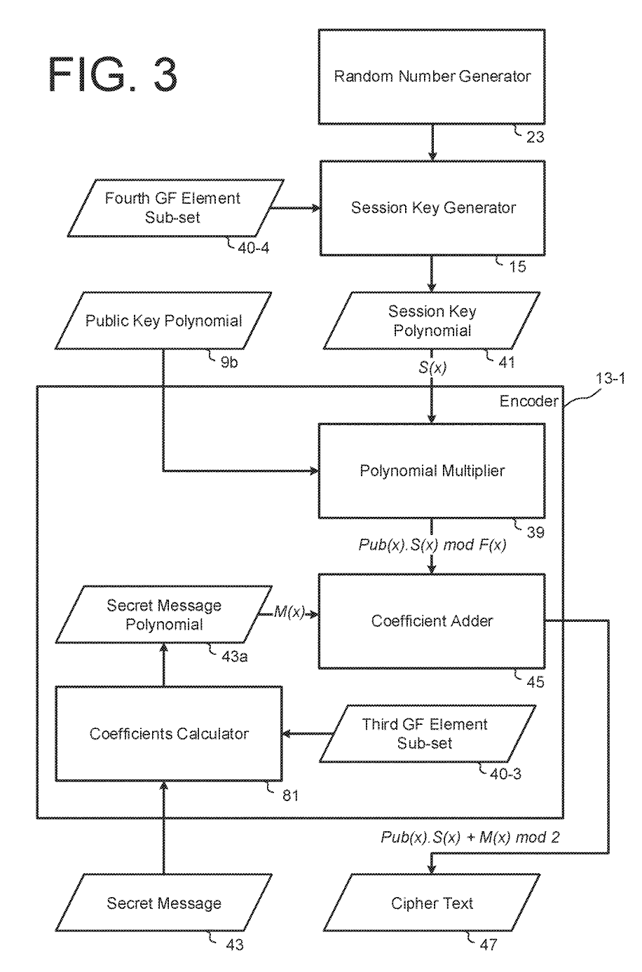

FIG. 3 is a functional block flow diagram illustrating the generation of cipher text for a given input message by an encoding module 13-1 according to an exemplary embodiment. In this embodiment, the secret message polynomial, M(x), derived for example from input plaintext to be encrypted by the encoder 13-1, comprises coefficients from a third sub-set of the Galois field 40-3, namely 1000 and 0000. As a worked example, a secret message M(x) may be represented as the polynomial:

M(x)=1+x²+x³+x⁶+x⁷+x⁸+x⁹+x¹⁰

In binary representation, the coefficients of this example secret message are:
1 0 1 1 0 0 1 1 1 1 1 0 0 0
0 0 0 0 0 0 0 0 0 0 0 0 0 0
0 0 0 0 0 0 0 0 0 0 0 0 0 0
0 0 0 0 0 0 0 0 0 0 0 0 0 0

The random number generator 23 feeds an input data sequence, for example of random 1's and 0's, to a session key generator 15-1 which in this embodiment is configured to compute a constrained sub-set of coefficients from a fourth Galois field sub-set 40-4 of elements or symbols for a session polynomial S(x), in a similar manner as discussed above with reference to the constrained coefficients polynomial generator 37 shown in FIG. 2. The output coefficients define the generated session polynomial S(x) 41-1. Following from the present worked example, a random sequence output by the session key generator 15-1 comprises coefficients randomly selected from the fourth sub-set 40-4 consisting of Galois field symbols 1000, 0100, 1100 and 0000.

An example session key sequence of coefficients of S(x) in decimal numbers using the notation of Table 1 is:
3 3 2 3 0 1 0 0 2 2 0 3 3 3

Equivalently expressed, the session key polynomial is S(x)=α¹¹+α¹¹x+α¹⁴x²+α¹¹x³+α⁰x⁵+α¹⁴x⁸+α¹⁴x⁹+α¹¹x¹¹+α¹¹x¹²+α¹¹x¹³

By constraining coefficients of the various polynomials to be from predefined sub-sets of the Galois field makes it possible for the message polynomial to be contained within the cipher text but only recoverable through knowledge of the private key polynomial. The cipher text, C(x) is constructed by the encoder 13-1, as depicted in FIG. 3, by multiplying the session key polynomial 41-1 with the public key polynomial 9b modulo the defined fixed polynomial F(x), using a polynomial multiplier 39, and adding the message polynomial M(x) 43 modulo 2, i.e. binary Galois field addition, using a coefficient adder 45. Consequently, in the present worked example, the encoder 13-1 outputs cipher text 47 based on the computation:

C(x)=Pub(x)·S(x)+M(x)modulo 1+α⁻¹x+x¹⁴

With the example result:

C(x)=α¹¹+α¹⁴x+α¹⁰x²+α³x³+α¹¹x⁴+α¹⁰x⁶+α⁸x⁷+α¹²x⁸+α⁶x¹¹+α¹³x¹²+α¹²x¹³

The cipher text coefficients represented as decimal numbers are:
3 2 6 15 3 0 6 11 8 0 0 10 4 8

Before the addition of M(x), these coefficients are
2 2 7 14 3 0 7 10 9 1 1 10 4 8

It can be seen that the message is a small perturbation vector added to a vector that appears to be a pseudo random vector. Advantageously, the security provided by the system 1 is that without knowing the private key, it is impossible to determine which coefficients have been perturbed, except by computationally intractable trial and error.

In binary, the cipher text is:
1 0 0 1 1 0 0 1 0 0 0 0 0 0
1 1 1 1 1 0 1 1 0 0 0 1 0 0
0 0 1 1 0 0 1 0 0 0 0 0 1 0
0 0 0 1 0 0 0 1 1 0 0 1 0 1

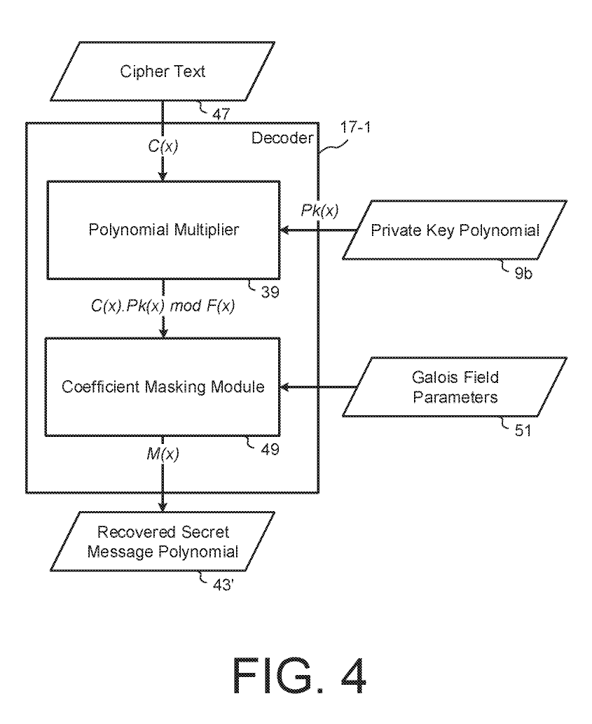

FIG. 4 is a functional block flow diagram illustrating the decryption of cipher text 47 by a decoder (decryptor) module 17 using the generated private key 9b, in an exemplary embodiment. The received cipher text 47 is input as input cipher text coefficient data to a polynomial multiplication module 39 of the decoder 17-1 along with the private key polynomial, Pk(x) 9b to produce the result:

$$\begin{matrix}C ( x ) \cdot Pk ( x ) = Pub ( x ) \cdot S ( x ) \cdot Pk ( x ) + M ( x ) \cdot Pk ( x ) modulo \\ 1 + {α}^{- 1} x + {x}^{14} \\ = Qk ( x ) \cdot Pk ( x ) \cdot B ( x ) \cdot S ( x ) + M ( x ) \cdot Pk ( x ) modulo \\ 1 + {α}^{- 1} x + {x}^{14} \\ = B ( x ) \cdot S ( x ) + M ( x ) \cdot Pk ( x ) modulo 1 + {α}^{- 1} x + {x}^{14}\end{matrix}$$

Advantageously, it can be seen that the product B(x)·S(x) has coefficients from binary Galois field (modulo 2) additions involving only α¹⁴, α¹³ and α¹² and not α⁰. The product M(x)·Pk(x)=M(x)+W(x) where W(x) has coefficients from the Galois field sub-set α⁴, α⁶, α⁹, α¹⁰, α¹², α¹³, α¹⁴ and 0 but not α⁰. Consequently, M(x), which only has coefficients which are α⁰ or 0, may be determined by the decoder 17-1 from the first binary row of the product C(x)·Pk(x). This may be seen clearly from the binary representation of B(x)·C(x):
0 0 0 0 0 0 0 0 0 0 0 0 0 0
0 0 1 1 0 1 0 0 1 0 1 1 1 0
0 0 1 1 1 0 0 1 1 0 0 1 1 1
0 1 0 0 0 0 1 0 1 0 0 1 1 0

The binary version of C(x)·Pk(x) is:
1 0 1 1 0 0 1 1 1 1 1 0 0 0
1 0 0 1 0 0 1 0 0 0 0 0 0 0
0 1 0 0 1 0 0 1 0 1 0 1 0 0
0 1 0 0 0 1 0 0 0 1 1 1 1 0

The output from the polynomial multiplication module 39 is passed to a coefficient masking module 49 of the decoder 17-1, which is used to mask off all but the first row of the input coefficient data. Following from the above worked example, the coefficient masking module 49 produces the output data:
1 0 1 1 0 0 1 1 1 1 1 0 0 0
0 0 0 0 0 0 0 0 0 0 0 0 0 0
0 0 0 0 0 0 0 0 0 0 0 0 0 0
0 0 0 0 0 0 0 0 0 0 0 0 0 0

It will be observed that this output is identical to the original binary representation of the coefficients of M(x).

It will be appreciated that in the present worked example, the reconstruction of M(x) has been possible by constraining coefficients of the private key Pk(x) to combinations of α¹⁴, α¹³, α¹⁰ and zero, apart from the x⁰ coefficient which is a⁰. In addition, the public key factor B(x) 38 has coefficients limited to α¹⁴ and zero. The session key S(x) has coefficients limited to combinations of α⁰, α¹⁴ and zero. M(x) has coefficients limited to α⁰ and zero. It is these restrictions to combinations of sub-field elements that enables M(x) to be reconstructed unambiguously from the cipher text by using the private key polynomial.

It is also appreciated that different choices of coefficient constraints for the above polynomials may be made with the result that it is possible, knowing the private key, to achieve unambiguous reconstruction of M(x). For example the public key factor B(x) 38 could have coefficients limited to α⁰ and zero with the session key S(x) having coefficients limited to combinations of α¹⁴, α¹³, α¹⁰ and zero.

In cases where the message may be shorter than N bits, the restriction on some coefficients may be removed. For example if the message is shortened by 4 bits, the first 4 symbols of the private key may also include α¹² further increasing the entropy in the selection of the private key. In addition the first 4 coefficients of the public key factor B(x) 38 may have coefficients which include α¹³ or the first 4 coefficients of the session key S(x) may have coefficients which include α¹³.

Furthermore the private key Pk(x) may have coefficients from combinations of α¹⁴, α¹³, α⁰ and zero but in this case the reconstructed message polynomial M′(x) derived by masking off all but the first row of the binary representation of the decrypted cipher text will need to be multiplied by the inverse of a polynomial D(x) defined by the α⁰ coefficients of Pk(x) in order to reconstruct the original message polynomial M(x).

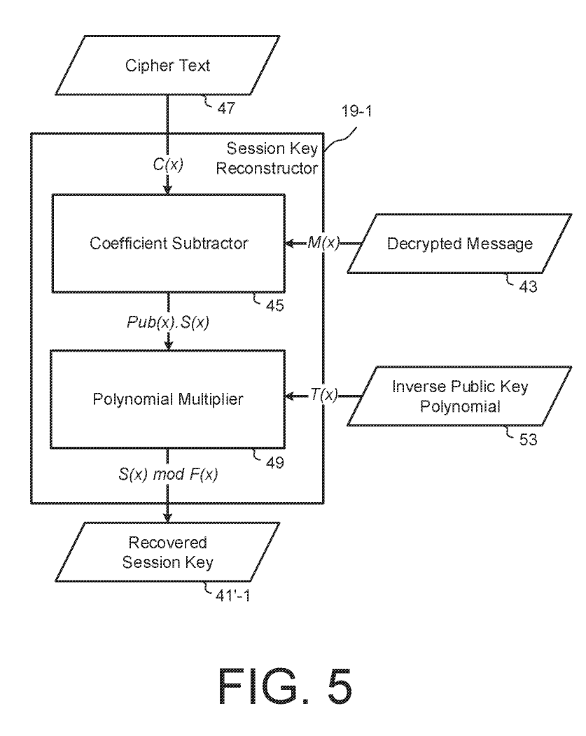

Having derived M(x) 43 from the received cipher text 47, it is possible to reconstruct the session key S(x) 41′-1. FIG. 5 is a functional block flow diagram illustrating the reconstruction of a session key by a session key reconstructor 19-1 in an embodiment, using corresponding reference numerals to those of preceding figures where appropriate for corresponding elements.

As shown, the session key reconstructor 19-1 receives input cipher text C(x) and decrypted message data M(x), and provides the data as input coefficient data to a coefficient adder 45 of the session key reconstructor 19-1, which computes the Galois field subtraction of input data, in this case modulo 2 addition. The computed output from the coefficient adder 45 is passed to a polynomial multiplier 39 of the session key reconstructor 19-1, which multiplies the received input with the inverse of the public key polynomial Pub(x), denoted as T(x), 53.

Since in the binary case C(x)−M(x)=C(x)+M(x)=Pub(x)·S(x), it can be seen that multiplying C(x)+M(x) by the inverse of Pub(x), T(x) 53, modulo the fixed polynomial F(x), produces the recovered session key S(x) 41′-1:

S(x)=[C(x)−M(x)]·T(x)modulo F(x)

It is appreciated that instead of choosing S(x) randomly, S(x) can convey 2N bits of information so that in total the cipher text conveys 3N bits of information.

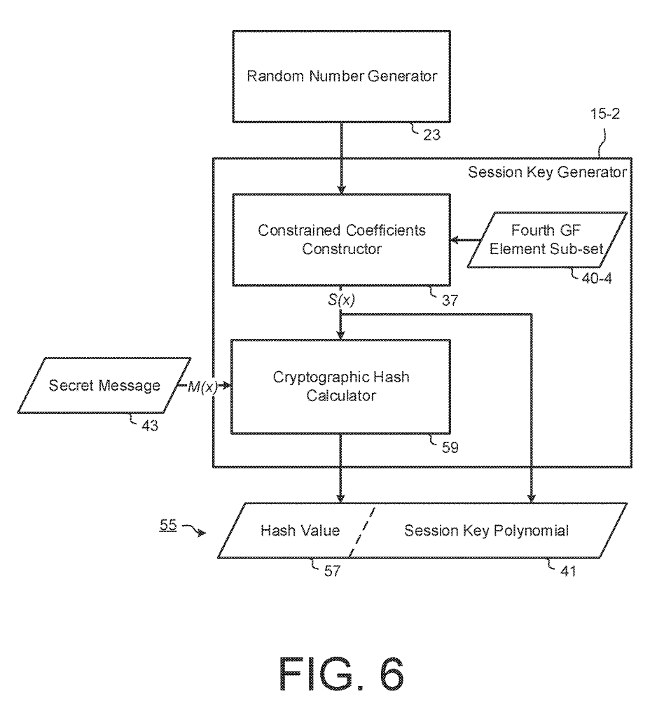

FIG. 6 is a block flow diagram of a session key generator 15-2 according to an alternative embodiment, using corresponding reference numerals to those of preceding figures where appropriate for corresponding elements. Similar to the embodiment discussed above with reference to FIG. 2, the session key 41-2 constructed by the session key generator 15-2 in this embodiment also includes a polynomial of constrained coefficients S(x) composed by a constrained coefficients constructor 37 of the session key generator 15-2 from random bits output by the random number generator 23. In this embodiment, the session key 41-2 constructed also includes a cryptographic hash value 57 that is calculated by a cryptographic hash calculator 59 of the session key generator 15-2 output, and the secret message M(x) 43. For example by employing SHA-3 using as input M(x) concatenated with the constrained coefficients S(x) output by the constrained coefficients constructor 37. In this way, the cryptosystem 1 in this embodiment advantageously provides indistinguishability under adaptive chosen ciphertext attack (IND-CCA2).

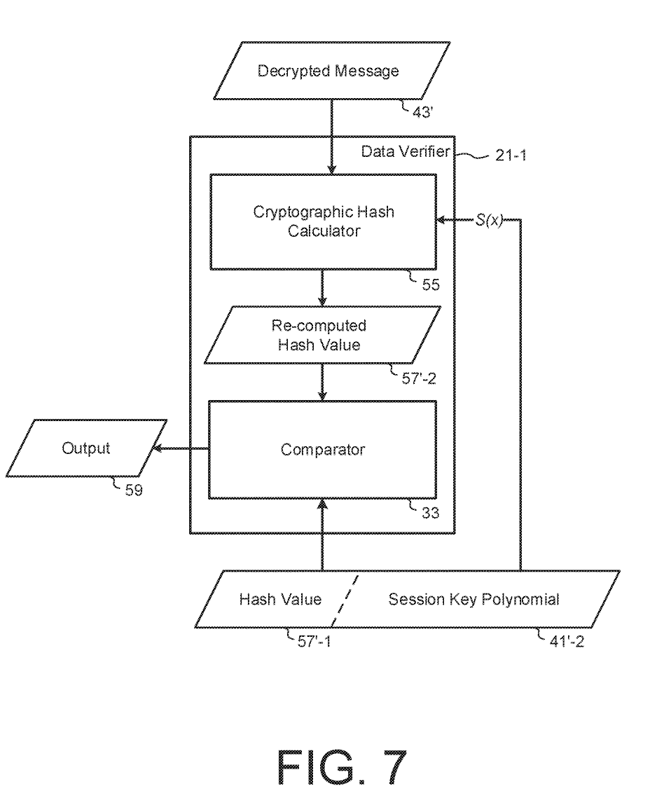

Correspondingly, a data verifier module 21-1 in such an alternative embodiment, as shown in the functional block flow diagram of FIG. 7 will output a null result 59 if the reconstructed session key 55 does not contain a cryptographic hash value 57′-1 that matches a re-computed hash value 57′-2 calculated by a hash calculator 59 of the data verifier 21-1 from the reconstructed/decrypted message M(x) 43′ concatenated with the constrained random coefficients vector S(x) of the reconstructed session key polynomial 41′-2. Advantageously, this arrangement defeats an adaptive chosen cipher text attack because any modified cipher text submitted to a decoder oracle (assumed to be available to the attacker) will produce a null result from the decoder as the cryptographic hashes 57′ will not match. It will be appreciated that the cryptographic hash calculator 55 may implement any type of hash function that is known per se, such as SHA-3 or H MAC, and need not be described further.

The random bits contained in the session key polynomial S(x) 41 provide semantic security in that the cipher text C(x) 47 is different each time the message M(x) 43 is encrypted even if M(x) 43 is the same because the session key polynomial S(x) 41 will be different each time.

The entropy of the public key may be increased by increasing the length of the cipher text. The entropy may also be increased by increasing the Galois field size of the coefficients of polynomials. This also provides more freedom in the choice of Galois field sub-sets for the constrained coefficients of the session key polynomial and message polynomial. As an example consider the Galois field GF(256) generated by the primitive polynomial 1+x²+x³+x⁴+x⁸.

With GF(256), the coefficients of the private key Pk(x) may now be constrained to be randomly selected combinations of α²⁵⁴, α²⁵³, α²⁵², α²⁵¹, α²⁵⁰, α²⁴⁹ and zero, apart from the x⁰ coefficient of Pk(x) which has α⁰ added to it. The public key factor B(x) 38 has randomly selected coefficients limited to the sub-set α²⁵⁴ and zero. The session key S(x) has randomly selected coefficients limited to the Galois field sub-set defined by all combinations of α⁰, α²⁵⁴, α²⁵³, α²⁵², α²⁵¹, α²⁵⁰, α²⁴⁹ and zero. The message M(x) has coefficients limited to α⁰ and zero. In terms of decimal numbers the coefficients may be defined by integer values in the inclusive range 0 to 255.

As an example for N=20, the private key polynomial Pk(x) has the following randomly chosen coefficients from the Galois field sub-set described above:
1 16 114 86 6 108 66 106 118 8 80 120 110 120 66 24 92 96 64 16

For N=20, the modulo polynomial F(x) is now modulo 1+a⁻¹X+x²⁰. The calculated inverse polynomial, modulo F(x), is Qk(x) which turns out to have the following coefficients:
173 54 64 203 152 170 192 209 2 246 65 53 45 219 26 134 246 213 153 23

The public key factor B(x) 38 has randomly selected coefficients:
2 2 2 0 0 2 2 2 0 0 0 2 0 2 2 0 2 2 0 0

The calculated public key Pub(x)=Qk(x)·B(x) has coefficients:
189 101 228 61 172 196 146 33 242 11 19 233 51 205 103 20 228 169 197 168

With a session key polynomial S(x) having randomly selected coefficients:
6 19 45 16 0 52 3 35 58 41 32 6 18 4 61 28 6 33 35 1

And message polynomial M(x) having coefficients:

1 1 0 0 0 1 1 1 1 1 0 0 0 0 0 1 1 0 0 0:

The constructed cipher text polynomial has coefficients:
33 199 150 153 218 8 108 133 185 134 93 5 75 235 251 130 109 37 40 76

This forms the cipher text.

Without addition of M(x) the vector is:
32 198 150 153 218 9 109 132 184 135 93 5 75 235 251 131 108 37 40 76

It can be seen that M(x) causes minor perturbations to this vector to form the cipher text. In binary representation the cipher text is:
1 1 0 1 0 0 0 1 1 0 1 1 1 1 1 0 1 1 0 0
0 1 1 0 1 0 0 0 0 1 0 0 1 1 1 1 0 0 0 0
0 1 1 0 0 0 1 1 0 1 1 1 0 0 0 0 1 1 0 1
0 0 0 1 1 1 1 0 1 0 1 0 1 1 1 0 1 0 1 1
0 0 1 1 1 0 0 0 1 0 1 0 0 0 1 0 0 0 0 0
1 0 0 0 0 0 1 0 1 0 0 0 0 1 1 0 1 1 1 0
0 1 0 0 1 0 1 0 0 0 1 0 1 1 1 0 1 0 0 1
0 1 1 1 1 0 0 1 1 1 0 0 0 1 1 1 0 0 0 0

After multiplying by Pk(x), the decrypted cipher text in binary is:
1 1 0 0 0 1 1 1 1 1 0 0 0 0 0 1 1 0 0 0
1 1 1 0 0 1 1 1 1 1 0 1 0 0 0 0 0 0 0 0
1 1 1 1 0 1 1 1 1 1 1 0 1 1 0 0 1 0 0 1
1 0 0 0 1 1 1 1 0 1 0 0 1 0 0 0 1 0 1 1
1 1 0 1 1 1 0 1 0 0 0 1 0 1 1 1 0 1 0 0
1 1 0 1 0 0 1 0 0 1 0 0 1 0 1 1 0 1 0 0
1 0 1 0 1 1 1 1 0 1 0 0 0 0 0 1 0 1 1 1
0 1 1 0 1 1 0 0 1 0 1 1 0 1 1 1 1 0 0 0

It will be noticed that the first row is identical to the message M(x) and this is obtained by masking off the first bit of the decrypted cipher text.

In the case of M(x)=0, the decrypted cipher text is:
0 0 0 0 0 0 0 0 0 0 0 0 0 0 0 0 0 0 0 0
0 0 1 1 1 0 0 1 0 0 0 1 1 1 0 0 0 1 1 0
0 1 1 1 1 1 0 0 1 1 1 1 0 1 0 1 1 1 0 0
0 0 1 0 0 0 0 0 0 0 1 0 1 1 0 1 0 0 1 0
1 0 0 0 1 1 0 0 0 1 0 0 1 0 0 1 0 1 1 1
1 0 1 0 1 0 1 1 1 0 1 0 0 1 1 0 0 0 1 1
0 0 1 1 1 0 0 1 0 0 0 1 0 1 0 0 1 0 1 0
0 0 1 0 1 1 0 0 0 0 1 0 1 1 1 0 1 0 0 0

It will be noticed that all the rows are now different. This is because M(x)·Pk(x) modulo 1+α⁻¹x+x²⁰ contributes to all of the rows and when M(x) is zero this contribution is zero.

The session key S(x) may be retrieved from the cipher text polynomial C(x) after the message M(x) has been reconstructed by subtracting M(x) from C(x) and multiplying by the inverse of the public key polynomial, modulo F(x).

This is because {C(x)−M(x)}·Pub(x)⁻¹=S(x)·Pub(x)·Pub(x)⁻¹=S(x).

This is useful when the session key S(x) is not generated from randomly selected coefficients but instead where coefficients of the session key carry or embody implanted additional information, such as the hash of the message or a second message.

### Embodiments Having Coefficients as Codewords

Further alternative embodiments use a different means of differentiating the message within the coefficients of the polynomial obtained by multiplying the cipher text polynomial by Pk(x) when decrypting the cipher text. As discussed above, the polynomial coefficients are Galois field elements defined by a primitive polynomial with a primitive root a. In this exemplary alternative embodiment different sub-sets of the Galois field symbols are defined, each of the Galois field elements may be split into a quotient times a code generator polynomial plus a remainder, termed the residue. For example, with primitive polynomial 1+x+x⁴ and with a as a primitive root, an example of a code generator polynomial in powers of α⁻¹ is:

Consider the field element 1+α⁻¹+α⁻³, this field element is represented by constituent data components:

1+α⁻¹+α³=(1+α⁻¹+α⁻²)(1+α⁻¹)+α⁻¹

Thus, the element 1+α⁻¹+α⁻³ may be considered as a codeword:

(1+α⁻¹+α⁻²)(1+α⁻¹)=1+α⁻³

plus a residue α⁻¹.

Similarly all of the other Galois Field elements may be split into binary representations of codewords plus residues, for example as shown in Table 2 for the representations of exemplary Galois Field size GF(2⁴).

TABLE 2
GF(2⁴) elements split into codewords plus residues

| | | | Decimal |
|---|---|---|---|
| Value | Codeword | Residue | Representation |
| 1000 | 0000 | 1000 | 1 |
| 1001 | 1001 | 0000 | 9 |
| 1011 | 0111 | 1100 | 13 |
| 1111 | 0111 | 1000 | 15 |
| 0111 | 0111 | 0000 | 14 |
| 1110 | 1110 | 0000 | 7 |
| 0101 | 1001 | 1100 | 10 |
| 1010 | 1110 | 0100 | 5 |
| 1101 | 1001 | 0100 | 11 |
| 0011 | 0111 | 0100 | 12 |
| 0110 | 1110 | 1000 | 6 |
| 1100 | 0000 | 1100 | 3 |
| 0001 | 1001 | 1000 | 8 |
| 0010 | 1110 | 1100 | 4 |
| 0100 | 0000 | 0100 | 2 |
| 0000 | 0000 | 0000 | 0 |

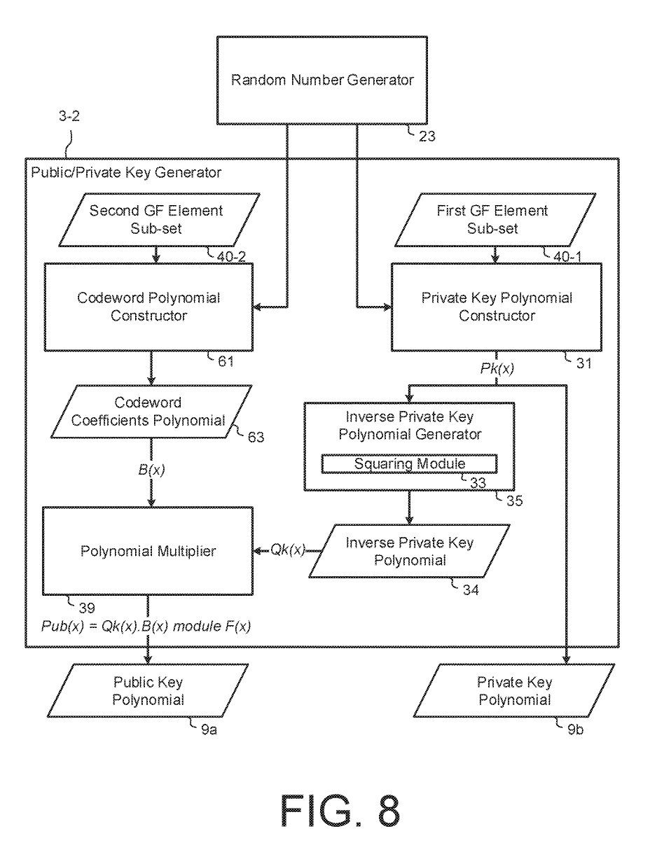

FIG. 8 is a functional block flow diagram illustrating the generation of public and private keys 9 by a key generator 3-2 according to a further embodiment, using corresponding reference numerals to those of preceding figures where appropriate for corresponding elements. As in the embodiments described above, the system 1 is illustrated by way of a simplified worked example using GF[2̂(5.16)] with GF(32) coefficients of polynomials of degree fifteen. The irreducible fixed polynomial F(x) is 1+α⁻¹x+x¹⁶. GF(32) is generated by primitive polynomial 1+x²+x⁵ with a as primitive root.

In this exemplary embodiment, the private key polynomial Pk(x), 9b is a binary polynomial, and the coefficients will be randomly chosen from the Galois field sub-set α⁰=1 or 0, with 16 coefficients. In the present worked example, the coefficients are:
0 0 0 1 0 0 1 0 0 1 1 1 1 1 0 1

So Pk(x)=x³+x⁶+x⁹+x¹⁰+x¹¹+x¹²+x¹³+x¹⁴

The inverse polynomial Qk(x) is found by the intermediate step of repeatedly squaring Pk(x), modulo 1+α⁻¹x+x¹⁶ until the result is Pk(x) as described above. Qk(x) may then be determined with the result that

Pk(x)·Qk(x)=1 modulo 1+α⁻¹x+x¹⁶

It is found that

(x³+x⁶+x⁹+x¹⁰+x¹¹+x¹²+x¹³+x¹⁴)w=(x³+x⁶+x⁹+x¹⁰+x¹¹+x¹²+x¹³+x¹⁴)modulo 1+α⁻¹x+x¹⁶ for w=2⁵⁹

And

Qk(x)=α²⁷+α¹⁸x+α¹¹x²+α²⁰x³+αx⁵+α¹³x⁶+α²²x⁷+α³x⁸+α¹²x⁹+α³⁰x¹⁰+α⁵x¹¹+α²⁴x¹²+α¹⁴x¹³+α²⁹x¹⁴+α¹¹x¹⁵

As shown in FIG. 8, the output of the random number generator 23 is input to a codeword polynomial constructor module 61 that limits the values so as to constrain the coefficients of a codeword polynomial B(x) 63 so that each coefficient is a codeword defined by a codeword generator polynomial with the added constraint that there are no codewords with the most significant bits equal to a 1. The second GF Element Sub-set 40-2 is Galois field elements which are codewords with the most significant bit equal to 0. Advantageously, this applied coefficient constraint prevents codeword coefficients 63 being changed into non-codewords as a result of polynomial multiplication of B(x) by a polynomial having coefficients restricted to α⁰ and 0, modulo the defined fixed polynomial F(x), e.g. 1+α⁻¹x+x¹⁶. In this worked example, the code generator polynomial is 1+α⁻¹+α⁻³, and the codeword coefficients polynomial B(x) 63 generated by the codeword polynomial constructor 61 is:

B(x)=α⁴+α⁴x⁴+α⁴x⁶+α⁴x⁷+α⁴x¹⁰+α⁴x¹¹+α⁴x¹²+α⁴x¹³+α⁴x¹⁴

The randomly generated codeword coefficients polynomial B(x) 63 may be stored together with the associated public and private key pair polynomials 9a,9b in the memory 11b of the receiver 3b.

As shown in FIG. 8, the public key polynomial Pub(x) 9a is obtained by a polynomial multiplier of the key generator 3-2 multiplying the codeword coefficients polynomial 63 by the inverse of the private key polynomial modulo the fixed polynomial F(x), that is:

Pub(x)=B(x)·Qk(x)modulo 1+α⁻¹x+x¹⁶

Following the present worked example, the polynomial multiplier 39 computes the public key polynomial as:

Pub(x)=α²⁶+α³x+α³x²+α¹⁶x³+α⁶x⁴+α²x⁵+α⁶x⁶+α²⁶x⁷+α²¹x⁸+α²³x⁹+α¹⁵x¹⁰+α⁷x¹¹+αx¹²+α⁹x¹³+α¹³x¹⁴+α²³x¹⁵

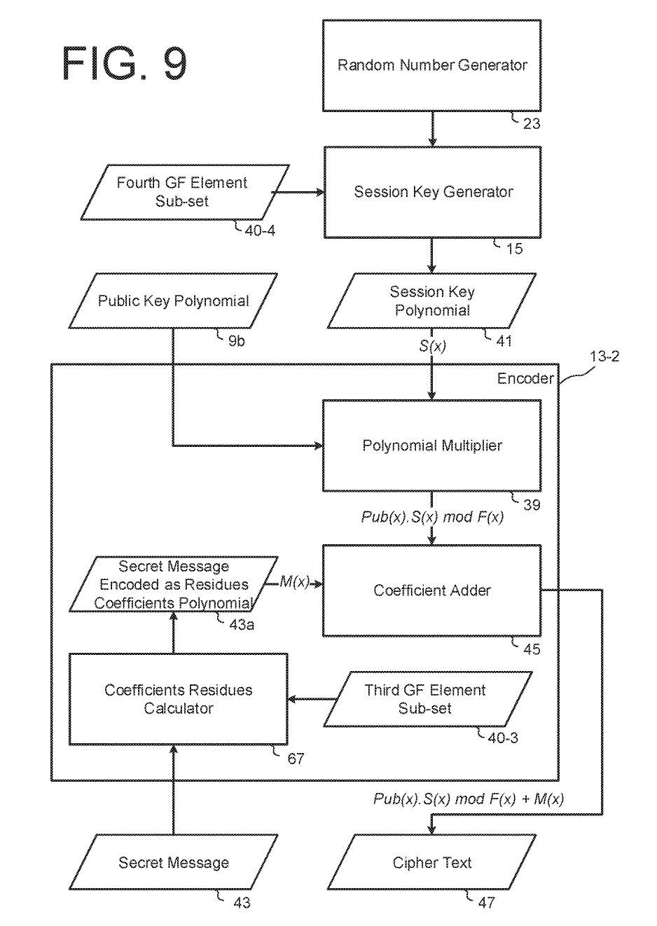

The corresponding encoder module 13-2 for constructing cipher texts in this alternative embodiment is shown in the block flow diagram of FIG. 9, using corresponding reference numerals to those of preceding figures where appropriate for corresponding elements. The random number generator 23 and session key generator 15, as discussed in embodiments above, is used to construct a session key polynomial S(x) 41 with constrained coefficients. In this example S(x) 41 will have binary coefficients, the coefficients randomly selected by the session key generator 15 from the fourth Galois field sub-set 40-4, α⁰=1 or zero, 0.

A worked example will be given with S(x)=x³+x⁶+x⁷+x¹¹+x¹²+x¹³+x¹⁵

In this example, the message polynomial M(x) 43a consists of coefficients which are residues consisting of all four additive combinations of 0, 1 and α⁻¹.

An example is:

M(x)=α¹³x²+α³⁰x⁵+α³⁰x⁷+α¹³x⁹+α³⁰x¹¹+α¹³x¹²+α³⁰x¹⁴+α³⁰x¹⁵

As shown in FIG. 9, the cipher text C(x) 47 is constructed by multiplying the session key polynomial 41 with the public key polynomial 9b, modulo the fixed polynomial F(x), using a polynomial multiplier 39 of the encoder 13-2, and adding the residue coefficients polynomial resulting from encoding the input secret message 43 as a residues coefficients polynomial 43a, using a coefficients residues calculator. Accordingly, in the present worked example, the encoder 13-2 produces the cipher text 47 by computing:

C(x)=Pub(x)·S(x)modulo F(x)+M(x), where F(x) is 1+α⁻¹x+x¹⁶

resulting in the example output cipher text 47:

C(x)=α²²+α²⁸x+α¹⁶x²+α¹⁴x⁴+α²⁸x⁵+α¹⁶x⁶+α¹⁹x⁷+α²¹x⁸+α⁰x⁹+α¹⁸x¹⁰+α²⁷x¹¹+α²⁸x¹²+α²⁴x¹³+α¹⁸x¹⁴+α¹³x¹⁵

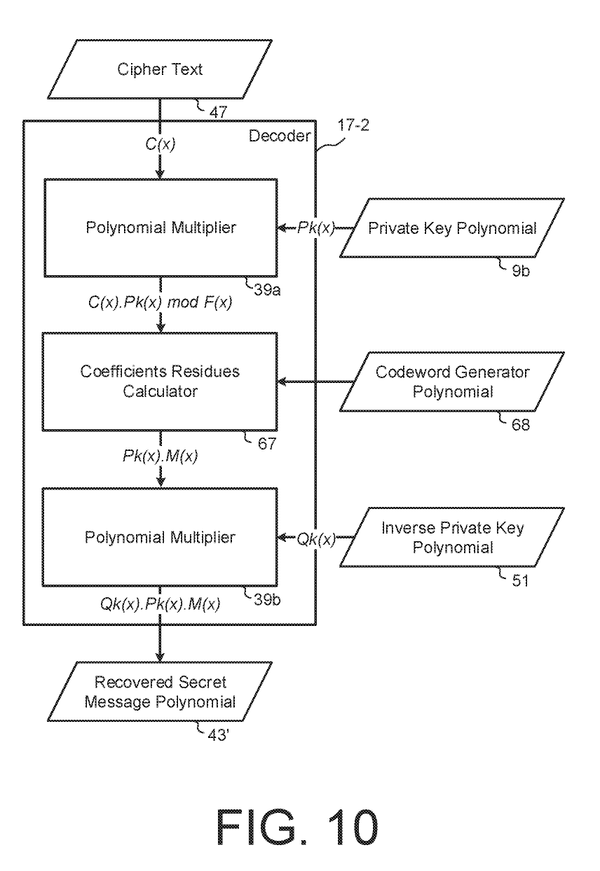

FIG. 10 is a block flow diagram of the corresponding decoder module 17-2 for decrypting the cipher text 47 produced by the encoder 13-2 discussed above with reference to FIG. 9.

As shown, the decoder 17-2 receives the cipher text polynomial C(x) 47 and uses a first polynomial multiplier 39a to multiply C(x) 47 by the private key polynomial Pk(x) retrieved from memory 11b, modulo the defined fixed polynomial F(x). Following from the present worked example where F(x) is 1+α⁻¹x+x¹⁶, the first polynomial multiplier 39 produces the output:

$$\begin{matrix}C ( x ) \cdot Pk ( x ) = Pk ( x ) \cdot Pub ( x ) \cdot S ( x ) \cdot Pk ( x ) \cdot M ( x ) modulo \\ 1 + {α}^{- 1} x + {x}^{16} \\ = B ( x ) S ( x ) + Pk ( x ) \cdot M ( x ) modulo 1 + {α}^{- 1} x + {x}^{16}\end{matrix}$$

As discussed above, in the present embodiment, the codeword coefficients polynomial B(x) 63 has coefficients which are codewords, and multiplication by S(x) which has binary coefficients will result in coefficients which are the sum of codewords, some of which are multiplied by α⁻¹ due to the modulo 1+α⁻¹x+x¹⁶ operation. This explains why the coefficients of B(x) were constrained to exclude codewords with the most significant bit equal to a 1. Advantageously, this provides space within the Galois field sub-set for the codeword coefficients to be multiplied by α⁻¹ without incurring a primitive polynomial, e.g. 1+x²+x⁵, modulo operation which would otherwise result in coefficients that are no longer codewords from the defined sub-set of the Galois field.

Consequently, following from the present worked example, B(x)·S(x) modulo 1+a⁻¹x+x¹⁶ has coefficients which are all codewords. Similarly, the private key Pk(x) 9b is a polynomial with binary coefficients so that Pk(x)·M(x) modulo F(x), e.g. 1+α⁻¹x+x¹⁶, is a polynomial whose coefficients are all residues. The secret message M(x) polynomial 43 was similarly constrained to have residue coefficients that could be multiplied by α⁻¹ and still remain residues.

Accordingly, as shown in FIG. 10, the residue of each coefficient of the polynomial C(x)·Pk(x) output by the first polynomial multiplier 39a is calculated by a coefficients residues calculator 67 of the decoder 17-2. The coefficients residues calculator 67 calculates the residue of each coefficient of the input polynomial by dividing the polynomial representation of each coefficient by the corresponding coefficient from the codeword polynomial 63 retrieved from the memory 11b. In the present worked example, the codeword generator polynomial 68 is 1+α⁻¹+α⁻³. This has the effect of eliminating from the product C(x)·Pk(x) the polynomial B(x) S(x) leaving only Pk(x)·M(x).

In the present example, the residues of the coefficients of C(x)·Pk(x) as decimal numbers are calculated by the coefficients residues calculator 67 to be:
1 1 4 4 2 6 3 0 7 6 4 6 4 6 5 5

As a polynomial representation, this is Pk(x)·M(x).

The original message M(x) 43′ is reconstructed by multiplying by the inverse of Pk(x) which is Qk(x), using a second polynomial multiplier 39b (which may be the same processing module as the first polynomial multiplier 39a), and the original secret message 43′ is recovered and output by the decoder 17-2 as shown in FIG. 10. In the present example, the output recovered message polynomial has the representative form:

M(x)=Qk(x)·Pk(x)·M(x)modulo F(x), where F(x) is 1+α⁻¹x+x¹⁶

### An Exemplary Codeword and Residue Coefficient Embodiment

The security strength of the codeword based system in the embodiments described above depends upon keeping the private key Pk(x) secret. In the systems described above, the worked example public key is computed as Pub(x)=Pk(x)⁻¹·B(x) modulo 1+α⁻¹x+0, where B(x) is a polynomial whose coefficients are all codewords. An attacker does not know the code generator polynomial 68, because this is part of the private key but there are not a large number of possibilities.

One possible strategy an attacker may use is to trial different versions of a polynomial Y(x) until a Y(x) is found such that Y(x)·Pub(x)=B(x), a polynomial whose coefficients are all codewords, trying in parallel all possible code generator polynomials. It is possible that an efficient algorithm may be found to carry out this attack.

To provide strength against such an attack, the public key may be constructed from multiple polynomials whose coefficients are both codewords and residues. Specifically in this exemplary system:

Pub(x)=Pk(x)⁻¹·[B₁(x)+R₁(x)]+B₂(x)+R₂(x)modulo 1+α⁻¹x+x^{N}

where B₁(x) and B₂(x) are polynomials whose coefficients are all codewords and R₁(x) and R₂(x) are polynomials whose coefficients are all residues.

The cipher text C(x) is constructed as:

C(x)=Pub(x)·S(x)+M(x)modulo 1+α⁻¹x+x^{N}

The session key polynomial S(x) 41 has coefficients which are from one sub-set of the Galois field. As one example the coefficients may be binary taking only values α⁰=1 and 0. The message polynomial M(x) has coefficients that are restricted to the Galois field sub-set that are all residues as defined by the codeword generator polynomial 68.

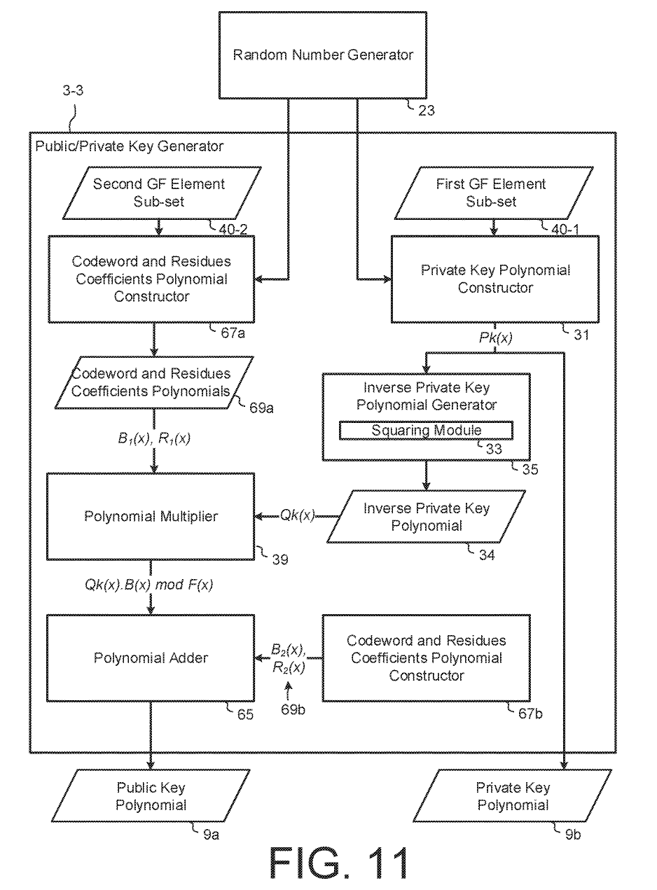

FIG. 11 is a block flow diagram showing a key generator 3-3 for constructing the public and private key pair 9 according to the present alternative embodiment, using corresponding reference numerals to those of preceding figures where appropriate for corresponding elements. As before, a simplified worked example is also given to illustrate the system in this alternative embodiment. In this worked example, the irreducible fixed polynomial F(x) is 1+α⁻¹x+x¹⁶. The finite Galois Field is GF(2^{12.16}), with coefficients of polynomials from GF(2¹²). The code generator polynomial 68, which may be kept secret, is 1+α⁻¹+α⁻²+α⁻⁴+α⁻⁵+α⁻⁷.

As shown in FIG. 11, the key generator 3-3 in this embodiment includes a first codeword and residues coefficients polynomial constructor 67a, which generates a first codeword polynomial B₁(x) and a corresponding first residues coefficients polynomial R₁(x), based on input random data from the random number generator 23. Collectively, the first codeword polynomial B₁(x) and residues coefficients polynomial R₁(x) will be referred to as first codeword and residues polynomials 69a. The coefficients of the codeword polynomial B₁(x) are all randomly chosen from the second Galois field GF(2¹²) sub-set 40-2 consisting of codewords, defined by the codeword generator polynomial 68, with the applied constraint that the codeword most significant bit is always 0. As decimal numbers, in this example, these coefficients are:
882 997 604 1885 715 1071 604 1071 1071 882 1430 1430 302 1281 1208 1764

The coefficients of the residues coefficients polynomial R₁(x) are all randomly chosen residues with the applied constraint that their most significant bit corresponds to α⁻⁵. As decimal numbers, in this example, these coefficients are:

21 60 19 60 6 36 32 52 8 12 36 40 4 59 12 61

As described in the embodiments above, a private key polynomial generator 31 of the key generator 3-3 produces a private key polynomial based on input random data from the random number generator 23 and a first sub-set 40-1 of the Galois field GF(2¹²) elements. In this worked example, the first sub-set of elements 40-1 is α⁰ and 0, and the generated private key polynomial Pk(x) is a binary polynomial with random coefficients:
1 0 0 1 0 1 1 0 1 0 1 0 0 1 0 1

The inverse of Pk(x), Qk(x) 34, is obtained using an inverse private key polynomial generator 35 of the key generator 3-3. The inverse private key polynomial 34 in the present worked example has computed coefficients:
648 2114 116 1783 3249 3803 716 1141 1377 2426 1556 3574 2764 115 2976 2913

A polynomial multiplier 39 of the key generator 3-3 receives the polynomial B(x) 38 output by the constrained coefficients polynomial generator module 37 with the inverse private key polynomial Qk(x) output by the inverse private key polynomial generator 35.

The key generator 3-3 in this embodiment includes a second codeword and residues coefficients polynomial constructor 67b (which may be the same processing module as the first polynomial constructor 67a) that generates a second codeword polynomial B₂(x) and a corresponding second residues coefficients polynomial R₂(x), based on input random data from the random number generator 23. Collectively, the second codeword polynomial B₂(x) and residues coefficients polynomial R₂(x) will be referred to as second codeword and residues polynomials 69b. The coefficients of the polynomial B₂(x) are also all randomly chosen by the constructor 67b from the second GF(2¹²) sub-set 40-2, consisting codewords with the two most significant bits always equal to 0. As decimal numbers, in this example, these coefficients are:
604 302 882 997 715 882 882 151 441 882 715 882 882 882 604 441

The coefficients of the polynomial R₂(x) are all randomly chosen residues with the constraint that their most significant bit corresponds to α⁻⁴. As decimal numbers, in this example, these coefficients are:
5 6 5 20 31 23 28 13 13 13 9 12 28 14 26 17

As shown in FIG. 11, the public key polynomial 9a is constructed by the key generator 3-3 in this embodiment by multiplying the first codeword and residues polynomials 69a by the inverse private key polynomial 34, using a polynomial multiplier 39, and adding the output of the polynomial multiplier 39 to the second codeword and residues polynomials 69b, using a polynomial adder 65. In the present worked example, the output public key polynomial 9a is represented as:

Pub(x)=Qk(x)[B₁(x)+R₁(x)]+B₂(x)+R₂(x)modulo F(x),
where F(x) is 1+α⁻¹x+x¹⁶

The coefficients of Pub(x) in this example are found to be:
3520 924 4070 2282 2257 2864 3953 1109 1027 406 3317 3630 3537 3298 2521 1870

Once the public key polynomial Pub(x) 9a has been obtained and communicated to the transmitter device 3a, cipher texts may be constructed using the encoder 13 of the transmitter device 3a for example as discussed above with reference to FIG. 9.

Decryption of an example cipher text according to the present alternative embodiment will now be described, following from the present worked example. As discussed above, the session key S(x) has randomly chosen coefficients which are from the predefined fourth sub-set 40-4 of the Galois field. Following from the above worked example, the predefined sub-set 40-4 is α⁰ and 0, and the session key 41 coefficients S(x) are the binary values:
0 1 1 1 0 0 1 0 1 1 0 1 1 1 0 1

The message polynomial M(x) has coefficients which are residues such that their most significant bit corresponds to α⁻⁵. As decimal numbers, in this worked example, these coefficients values are:
28 33 1 45 26 41 20 19 12 44 13 53 11 10 61 5

The cipher text polynomial C(x)=Pub(x)S(x) modulo 1+α⁻¹x+x¹⁶+M(x)

In this example, the cipher text polynomial C(x) coefficients are:
1629 1849 3563 1551 1937 3636 1060 3783 199 3707 259 778 3952 2012 3933 3804

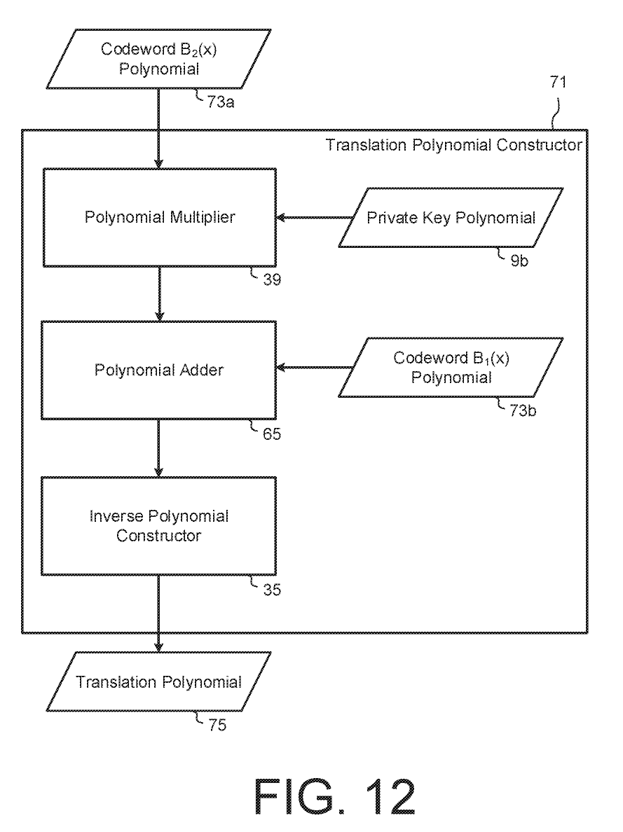

In order to decrypt the cipher text encoded using the public key polynomial 9a generated by the key generator 3-3 as discussed above with reference to FIG. 11, a Translation polynomial T(x) 75 is required. FIG. 12 is a block flow diagram of a translation polynomial constructor 71 configured to construct a translation polynomial T(x) 75. As shown, the second codeword polynomial B₂(x), as generated by the second codeword and residues coefficients polynomial constructor 67b of the key generator 3-3, is multiplied by the private key polynomial Pk(x) 9b retrieved from the memory 11, modulo the fixed polynomial F(x), i.e. 1+α⁻¹x+x¹⁶, using a polynomial multiplier 39.

The resulting output from the polynomial multiplier 39 is added to the first codeword polynomial B₁(x), as generated by the first codeword and residues coefficients polynomial constructor 67a of the key generator 3-3, and resulting polynomial is passed to an inverse polynomial constructor 35 to calculate the inverse polynomial to form the translation polynomial 75:

T(x)=[Pk(x)·B₂(x)modulo 1+α⁻¹x+x¹⁶+B₁(x)]⁻¹

In the present worked example, the coefficients of the translation polynomial T(x) are:
831 1040 3673 395 2216 1228 3188 459 1994 890 1092 237 2940 4030 3497 1863

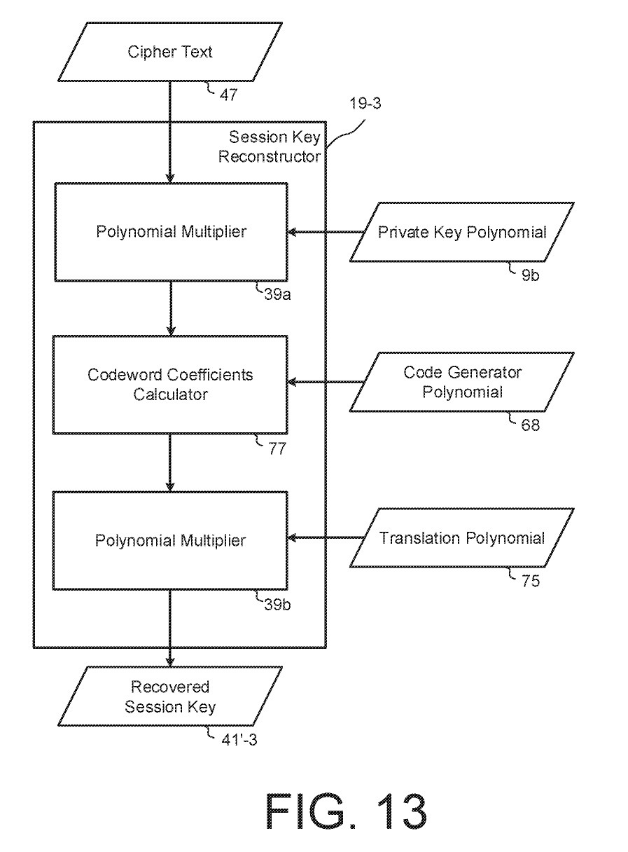

FIG. 13 is a block flow diagram of the corresponding session key reconstructor 19-3 to recover the session key S(x) for decryption of the cipher text 47 according to the present alternative embodiment, using corresponding reference numerals to those of preceding figures where appropriate for corresponding elements. As shown, the received cipher text polynomial 47 is first multiplied by the retrieved private key polynomial 9b modulo the fixed polynomial F(x), using a first polynomial multiplier 39a of the session key reconstructor 19-3, to form an intermediate polynomial U(x). In the present worked example, the output intermediate polynomial U(x)=C(x)·Pk(x) modulo 1+α⁻¹x+x¹⁶

$$\begin{matrix}So U ( x ) = Pub ( x ) \cdot S ( x ) \cdot Pk ( x ) + M ( x ) \cdot Pk ( x ) \\ = S ( x ) Pk ( x ) Qk ( x ) [ [ {B}_{1} ( x ) + {R}_{1} ( x ) ] + {B}_{2} ( x ) + {R}_{2} ( x ) ] + \\ M ( x ) \cdot Pk ( x ) modulo 1 + {α}^{- 1} x + {x}^{16} \\ = S ( x ) \cdot [ [ {B}_{1} ( x ) + {R}_{1} ( x ) ] + Pk ( x ) \cdot [ {B}_{2} ( x ) + {R}_{2} ( x ) ] ] + M ( x ) \cdot \\ Pk ( x ) modulo 1 + {α}^{- 1} x + {x}^{16}\end{matrix}$$

In this example, the coefficients of U(x), computed and output by the polynomial multiplier 39, are:
1629 3800 501 2394 803 1338 3679 2658 189 2063 2143 362 2248 2999 1618 2170

Each coefficient of U(x) is divided by the code generator polynomial 68, which in this worked example is 1+α⁻¹+α⁻²+α⁻⁴+α⁻⁵+α⁻⁷, and the computed residues are added modulo 2 to the corresponding coefficients of the intermediate polynomial U(x), using a codeword coefficients calculator 77 of the session key reconstructor 19-3. This process turns every coefficient of U(x) into a codeword. Denoting this codeword polynomial as V(x), the coefficients of V(x) output by the codeword coefficients calculator 77 in this worked example are:
1651 3770 441 2416 882 1281 3629 2562 151 2142 2142 302 2249 3003 1651 2142

Examining the components of U(x), the terms S(x)·B₁(x)+Pk(x)·S(x)·B₂(x) modulo 1+α⁻¹x+x¹⁶ have coefficients which are codewords and the terms S(x)·R₁(x)+Pk(x)·S(x)·R₂(x)+M(x)·Pk(x) modulo 1+α⁻¹x+x¹⁶ have coefficients which are residues. This is because S(x) and Pk(x) are binary polynomials and the terms S(x)·R₁(x)+Pk(x)·S(x)·R₂(x)+M(x)·Pk(x) modulo 1+α⁻¹x+x¹⁶ have coefficients which remain as residues after the polynomial multiplications despite the modulo 1+α⁻¹x+x¹⁶ operation because of the coefficient constraints that were imposed on R₁(x), R₂(x) and M(x).

Accordingly V(x)=S(x)·[B₁(x)+Pk(x)·B₂(x)] modulo 1+α⁻¹x+x¹⁶

The codeword polynomial V(x) is multiplied by the translation polynomial T(x) modulo F(x)=1+α⁻¹x+x¹⁶, using a second polynomial multiplier 39b of the session key reconstructor 19-3 (which may be the same processing module as the first polynomial multiplier 39a), to reproduce the session key 41′-3, e.g.:
0 1 1 1 0 0 1 0 1 1 0 1 1 1 0 1

This is because V(x)·T(x)=S(x)·[B₁(x)+Pk(x)·B₂(x)]·[B₁(x)+Pk(x)·B₂(x)]⁻¹ modulo 1+α⁻¹x+x¹⁶=S(x).

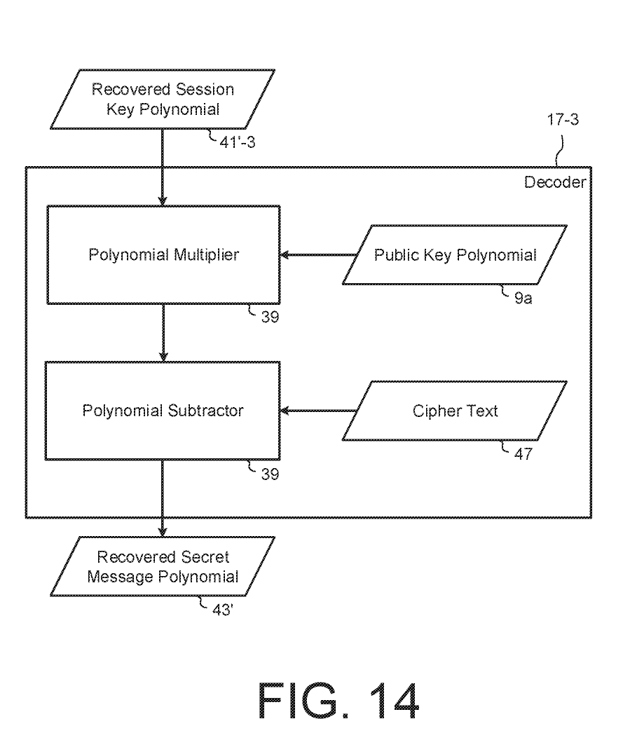

Having recovered the session key, S(x) 41′-3, the decoded message polynomial 43′ may be determined by the corresponding decoder 17-3 of this alternative embodiment, as shown in the block flow diagram of FIG. 14. As shown, the decoder 17-3 recovers the secret message polynomial 43′ by multiplying the retrieved public key polynomial 9a by the recovered session key S(x) 41′-3, using a polynomial multiplier 39 of the decoder 17-3, and subtracting (same as adding modulo 2 in GF(21), the resulting product from the cipher text 47, using a polynomial adder/subtractor 39 of the decoder 17-3:

C(x)+Pub(x)·S(x)=M(x)+Pub(x)·S(x)+Pub(x)·S(x)=M(x)

### Other Embodiments Using Circulant Polynomials

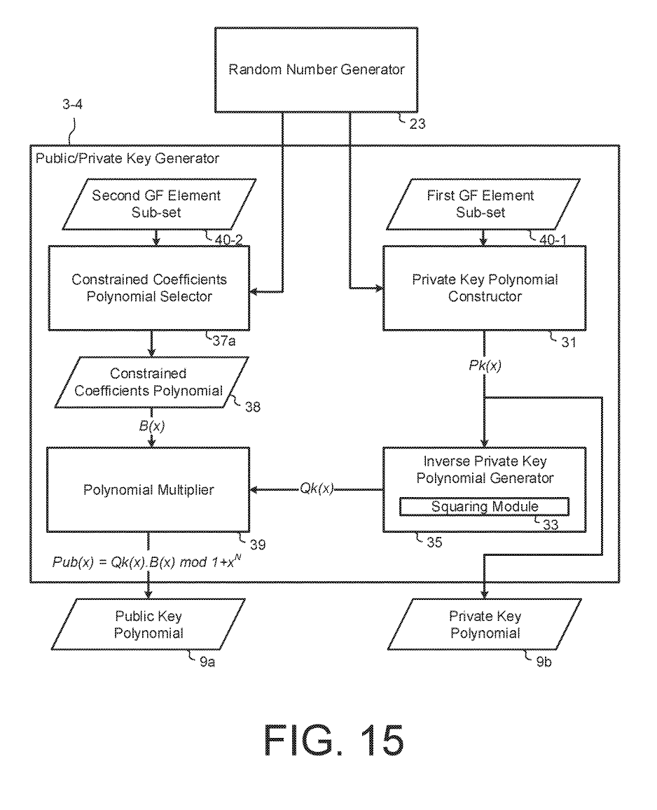

In some implementations it is attractive to use circulant polynomials because these have the simplest polynomial modulo operation in that all that needs to be carried out is just a circular shift. In another alternative embodiment, the fixed modulo polynomial F(x) instead has the form 1+x^{N}, where the public, private key, message and cipher text polynomials have N coefficients each corresponding to N Galois field symbols. FIG. 15 is a block flow diagram of a key generator 3-4 according to this alternative embodiment implementing such circulant polynomials, using corresponding reference numerals to those of preceding figures where appropriate for corresponding elements.

As discussed in embodiments above, the private key polynomial Pk(x) 9b consists of a polynomial of degree N−1 having symbols from a base prime power Galois field GF(b^{k}), commonly b=2, but any small prime power may be used. A typical value for k may be k=8. Also as before, the private key polynomial has coefficients which are randomly chosen from a first sub-set of the elements of GF(b^{k}) 40-1.

The inverse polynomial Qk(x) is determined from Pk(x) by repeatedly using a squaring module 33 of the inverse private key generator 35 as shown in FIG. 15, or alternatively by implementing the extended Euclidean algorithm or the Gaussian elimination inverse method. The result is that:

Pk(x)·Qk(x)=1 modulo 1+x^{N}

Since the circulant polynomial 1+x^{N} is not an irreducible polynomial, not all examples for Pk(x) will have an inverse polynomial. Consequently, more than one candidate Pk(x) may need to be generated by the private key constructor 31 before a corresponding inverse Qk(x) is determined.

As shown in FIG. 15, a constrained coefficients polynomial 37 is randomly selected by a constrained coefficients polynomial selector 37a. The selected coefficients are from a second sub-set of the GF(b^{k}) elements 40-2. The output selected coefficients form the polynomial B(x).

The public key polynomial 9a is obtained by the polynomial multiplier 39 multiplying the constrained coefficients polynomial B(x) 38 with the inverse private key polynomial Qk(x), modulo F(x)=1+x^{N}, as shown in FIG. 15:

Pub(x)=B(x)·Qk(x)modulo 1+x^{N}.

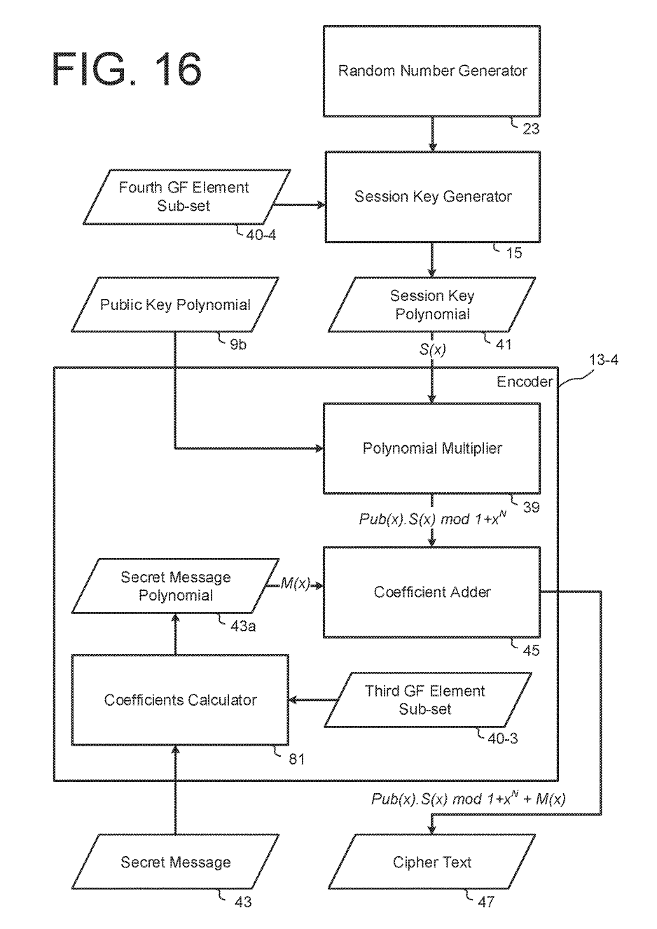

FIG. 16 is a block flow diagram showing the corresponding encoder 13-4 for generation of cipher texts 47 using the public key polynomial 9b generated by the key generator 3-4 of the present alternative embodiment, for the binary case where b=2. As shown, in this embodiment a coefficients calculator 81 computes a polynomial representation M(x) of the input secret message 43, where the coefficients of the polynomial representation M(x) are constrained to a third sub-set of the GF elements 40-3. In this embodiment, the session key polynomial is generated by the session key generator 15 randomly selecting constrained coefficients for the session key polynomial S(x) 41, based on output from the random number generator 23. The coefficients of S(x) are randomly selected from a fourth sub-set of the GF(2^{k}) elements 40-4 (since b=2 in this example). The secret message polynomial coefficients 43a output by the coefficients calculator 81 are added by a coefficient adder 45 of the encoder 13-4 to the product of the retrieved public key polynomial 9a and the session key polynomial 41, modulo 1+x^{N}, computed using a polynomial multiplier 39 of the encoder 13-4, to produce the cipher text 47 represented by the polynomial C(x):

C(x)=Pub(x)·S(x)modulo F(x)+M(x),

where F(x) in this embodiment is 1+x^{N}.

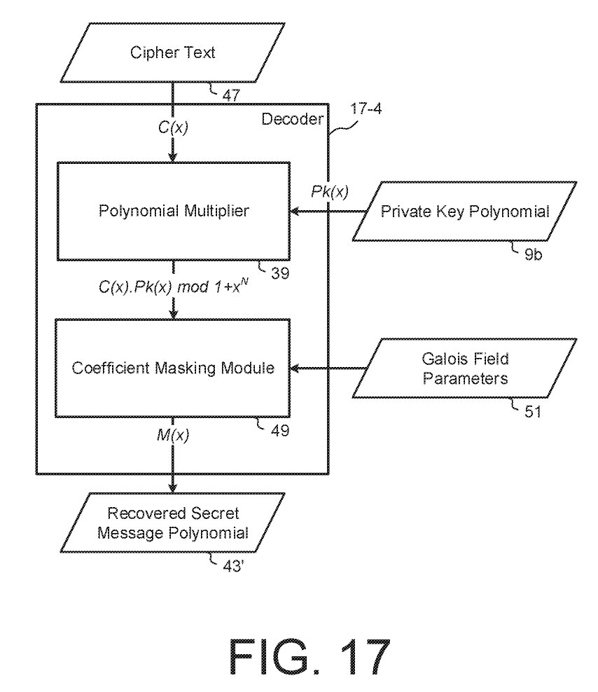

FIG. 17 is a block flow diagram of the corresponding decoder module 17-4 for decrypting the cipher text 47 produced by the encoder 13-4 discussed above with reference to FIG. 16, using corresponding reference numerals to those of preceding figures where appropriate for corresponding elements. The procedure for decrypting the cipher text 47 to retrieve the secret message 43′ is similar to embodiments above except that the fixed modulo polynomial is 1+x^{N}, where the cipher text 47 is represented as a polynomial multiplied by the private key polynomial 9b modulo 1+x^{N}, using the polynomial multiplier 39 of the decoder 17-4 as shown in FIG. 17. A sub-set of the coefficients of the resulting polynomial are selected by a coefficient masking module 49 of the decoder 17-4 in this embodiment. The resulting output from the coefficient masking module 49 is the recovered secret message represented as the polynomial M(x) 43′:

M(x)=Mask{C(x)·Pk(x)modulo 1+x^{N}}

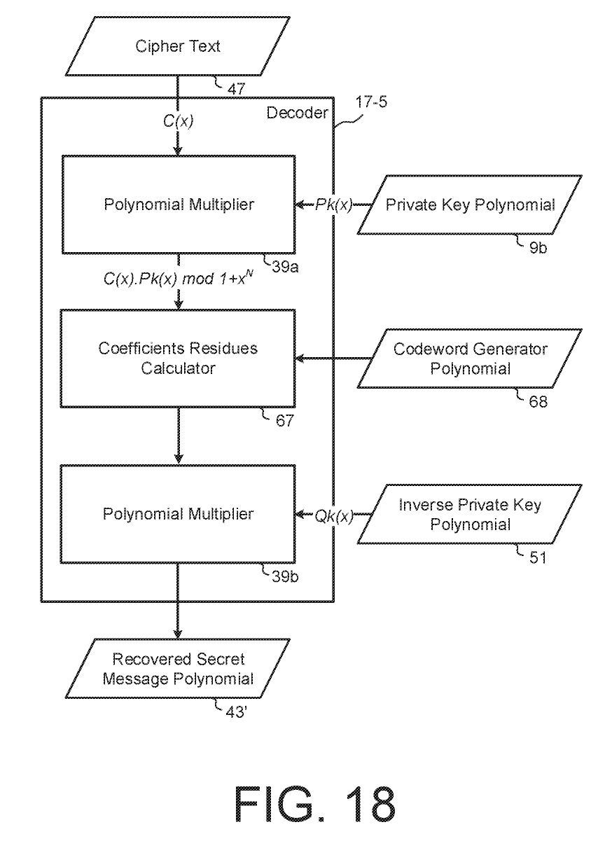

It will be appreciated that a circulant version of the codeword and residue coefficient embodiments as discussed above with reference to FIGS. 11 to 14 can be implemented by using the fixed modulo polynomial F(x)=1+x^{N}. For example, FIG. 18 is a block flow diagram showing the exemplary decoder module 17-5 for such a modified alternative embodiment.

### Example Computer System Implementation

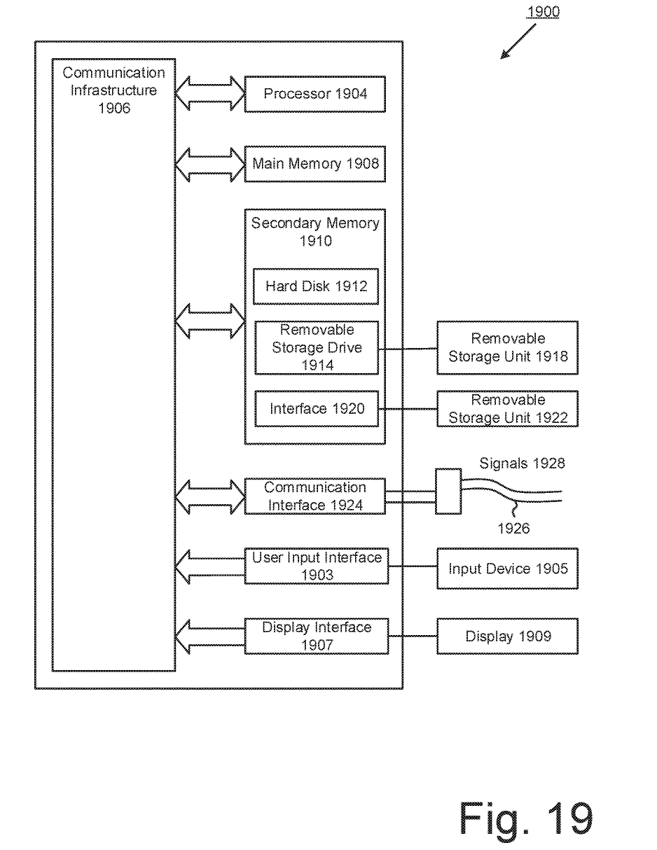

Various aspects of the present invention can be implemented by software, firmware, hardware, or a combination thereof. FIG. 19 illustrates an example computer system 1900 in which the present invention, or portions thereof, can be implemented as computer-readable code. For example, the computing and data processing entities and modules described herein, such as the key generators, encryption and decryption modules, codeword construction modules, and modules for cipher text construction and polynomial based calculations may be implemented by software and/or hardware components of one or more such computer systems. Various embodiments of the invention are described in terms of this example computer system 1900. After reading this description, it will become apparent to a person skilled in the art how to implement the various embodiments of the invention using other computer systems and/or computer architectures and other signal processing hardware/circuits.

Computer system 1900 includes one or more processors, such as processor 1904. Processor 1904 can be a special purpose or a general-purpose processor. Processor 1904 is connected to a communication infrastructure 1906 (for example, a bus, or network).

Computer system 1900 also includes a main memory 1908, preferably random access memory (RAM), and may also include a secondary memory 1910. Secondary memory 1910 may include, for example, a hard disk drive 1912, a removable storage drive 1914, flash memory, a memory stick, and/or any similar non-volatile storage mechanism. Removable storage drive 1914 may comprise a floppy disk drive, a magnetic tape drive, an optical disk drive, a flash memory, or the like. The removable storage drive 1914 reads from and/or writes to a removable storage unit 1918 in a well-known manner. Removable storage unit 1918 may comprise a floppy disk, magnetic tape, optical disk, etc. which is read by and written to by removable storage drive 1914. As will be appreciated by persons skilled in the relevant art(s), removable storage unit 1918 includes a non-transitory computer usable storage medium having stored therein computer software and/or data.

In alternative implementations, secondary memory 1910 may include other similar means for allowing computer programs or other instructions to be loaded into computer system 1900. Such means may include, for example, a removable storage unit 1922 and an interface 1920. Examples of such means may include a program cartridge and cartridge interface (such as that found in video game devices), a removable memory chip (such as an EPROM, or PROM) and associated socket, and other removable storage units 1922 and interfaces 1920 which allow software and data to be transferred from the removable storage unit 1922 to computer system 1900.

Computer system 1900 may also include a communications interface 1924. Communications interface 1924 allows software and data to be transferred between computer system 1900 and external devices. Communications interface 1924 may include Wireless or mobile communications infrastructure, a modem, a network interface (such as an Ethernet card), a communications port, a PCMCIA slot and card, or the like.

Computer system 1900 may additionally include computer display 1909. According to an embodiment, computer display 1909, in conjunction with display interface 1907, can be used to display interfaces of associated user applications.

In this document, the terms “computer program medium,” “non-transitory computer readable medium,” and “computer usable medium” are used to generally refer to media such as removable storage unit 1918, removable storage unit 1922, and a hard disk installed in hard disk drive 1912. Computer program medium, computer readable storage medium, and computer usable medium can also refer to memories, such as main memory 1908 and secondary memory 1910, which can be memory semiconductors (e.g. DRAMs, etc.). These computer program products are means for providing software to computer system 1900.

Computer programs (also called computer control logic) are stored in main memory 1908 and/or secondary memory 1910. Computer programs may also be received via communications interface 1924. Such computer programs, when executed, enable computer system 1900 to implement the present invention as discussed herein. In particular, the computer programs, when executed, enable processor 1904 to implement the processes of the present invention, such as the system component architectures of FIGS. 1 to 18 discussed above. Accordingly, such computer programs represent controllers of the computer system 1900. Where the invention is implemented using software, the software may be stored in a computer program product and loaded into computer system 1900 using removable storage drive 1914, interface 1920, hard drive 1912, or communications interface 1924.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, USB memory sticks, floppy disks, CD ROMS, ZIP disks, tapes, magnetic storage devices, optical storage devices, MEMS, nano-technological storage device, etc.), and communication mediums (e.g., wired and wireless communications networks, local area networks, wide area networks, intranets, Cloud based services, etc.).

### FURTHER ALTERNATIVES AND MODIFICATIONS

It will be understood that the various embodiments of the present invention are described by way of example only, and that various changes and modifications may be made without departing from the scope of the invention. In particular, it will be appreciated that aspects of the above discussed embodiments may be combined to form further embodiments. It should also be appreciated that the sub-modules of each of the key generator, encoder, decoder, session key generator, session key reconstructor, etc. may be combined into a single module or divided into additional modules, and/or share or use common processing modules/components, such as the polynomial multiplier, adder, etc. The system and processing modules may also include other components, sub-components, sub-modules, and devices commonly found in a computing system/device, which are not illustrated in the Figures for clarity of the description.

Yet further alternative embodiments may be envisaged, which nevertheless fall within the scope of the following claims.

1. A method of encrypting a digital message, the method comprising:
(a) generating a private key polynomial having coefficients from a first sub-set of predefined Galois field elements;
(b) constructing an inverse private key polynomial having coefficients which are an inverse of said private key polynomial where the polynomial product of the private key polynomial and the inverse private key polynomial modulo a third polynomial F(x) is equal to 1;
(c) generating a polynomial B(x) having coefficients from a second sub-set of said Galois field elements;
(d) constructing a public key polynomial by multiplying the inverse private key polynomial by the polynomial B(x) modulo F(x);
(e) representing the digital message as a polynomial M(x) having coefficients from a third sub-set of said Galois field elements;
(f) generating a session key polynomial S(x) having coefficients from a fourth sub-set of said Galois field elements; and
(g) generating an encrypted message by multiplying the session key polynomial S(x) by the public key polynomial, modulo F(x), and adding the result to the message polynomial M(x) to produce a polynomial representation of a cipher text.

2. A method of encrypting a digital message, the method comprising:
(a) generating a private key polynomial having coefficients from a first sub-set of predefined Galois field elements;
(b) constructing an inverse private key polynomial having coefficients which are an inverse of said private key polynomial where the polynomial product of the private key polynomial and the inverse private key polynomial modulo a third polynomial F(x) is equal to 1
(c) generating a polynomial B₁(x) having coefficients from a second sub-set of said Galois field elements;
(d) generating a polynomial B₂(x) having coefficients from a third sub-set of said Galois field elements;
(e) generating a polynomial R₁(x) having coefficients from a fourth sub-set of said Galois field elements;
(f) generating a polynomial R₂(x) having coefficients from a fifth sub-set of said Galois field elements;
(g) constructing a public key polynomial by multiplying the inverse private key polynomial by the sum of the polynomial B₁(x) and R₁(x), modulo F(x), and then adding the polynomials B₂(x) and R₂(x);
(h) representing the digital message as a polynomial M(x) having coefficients from a sixth sub-set of said Galois field elements;
(i) generating a session key polynomial S(x) having coefficients from a seventh sub-set of said Galois field elements; and
(j) generating an encrypted message by multiplying the session key polynomial S(x) by the public key polynomial, modulo a polynomial F(x), and adding the result to the message polynomial M(x) to produce a polynomial representation of a cipher text.

3. The method of claim 1 in which a second message is contained in the session key polynomial S(x).

4. The method of claim 1 in which a hash function of the message is contained in the session key polynomial S(x).

5. The method of claim 1, further comprising reconstructing a message from the digital cipher text by means of a private key algorithm comprising:
(a) retrieving said cipher text from a communications channel or storage medium and representing the cipher text as a polynomial;
(b) multiplying the cipher text, represented as a polynomial, by the private key polynomial, modulo F(x);
(c) partitioning the resulting polynomial into a message polynomial M(x) and another polynomial each having coefficients from a different sub-set of said Galois field elements; and
(d) formatting the message from the coefficients of the message polynomial M(x).

6. The method of claim 1, further comprising reconstructing a message from the digital cipher text by means of a private key algorithm comprising:
(a) retrieving said cipher text from a communications channel or storage medium and representing the cipher text as a polynomial;
(b) multiplying the cipher text, represented as a polynomial, by the private key polynomial, modulo F(x);
(c) partitioning the resulting polynomial into two polynomials U(x), V(x), each having coefficients from a sub-set of the predefined Galois field elements;
(d) generating a polynomial D(x) which is the inverse of a polynomial whose coefficients are from a sub-set of said Galois field elements of the coefficients of the private key polynomial;
(e) multiplying the polynomial U(x) by the polynomial D(x), modulo F(x) to produce a message polynomial M(x); and
(f) formatting the message from the coefficients of the message polynomial M(x)

7. The method of claim 5, further comprising recovering the session key polynomial S(x) by subtracting the reproduced message polynomial from the cipher text polynomial and multiplying the result, modulo F(x) by the inverse of the public key polynomial.

8. The method of claim 7 in which a message is retrieved by formatting the coefficients of the reproduced session key polynomial S(x).

9. The method of claim 6, further comprising recovering the session key polynomial S(x) by subtracting the reproduced message polynomial from the cipher text polynomial and multiplying the result, modulo F(x) by the inverse of the public key polynomial.

10. The method of claim 7 in which the hash of the message is retrieved by formatting the coefficients of the reproduced session key polynomial S(x).

11. The method of claim 1 in which the modulo polynomial, F(x), is a circulant polynomial.

12. The method of claim 2 in which a second message is contained in the session key polynomial S(x).

13. The method of claim 2 in which a hash function of the message is contained in the session key polynomial S(x).

14. The method of claim 2, further comprising reconstructing a message from the digital cipher text by means of a private key algorithm comprising:
(a) retrieving said cipher text from a communications channel or storage medium and representing the cipher text as a polynomial;
(b) multiplying the cipher text, represented as a polynomial, by the private key polynomial, modulo F(x);
(c) partitioning the resulting polynomial into two polynomials U(x), V(x), each having coefficients from a sub-set of said predefined Galois field elements;
(d) generating a polynomial T(x) which is the inverse of a polynomial resulting from the sum of the polynomial B₂(x) and the product of the private key polynomial and the polynomial B₁(x), modulo F(x);
(e) multiplying the polynomial V(x) by the polynomial T(x), modulo F(x) to reproduce the session key polynomial S(x);
(f) subtracting the product of the public key polynomial and the reproduced session key polynomial S(x), modulo F(x) from said cipher text, represented as a polynomial to reproduce the message key polynomial M(x); and
(g) formatting the message from the coefficients of the reproduced message polynomial M(x).

15. The method of claim 14 in which a message is retrieved by formatting the coefficients of the reproduced session key polynomial S(x).

16. The method of claim 14 in which the hash of the message is retrieved by formatting the coefficients of the reproduced session key polynomial S(x).

17. The method of claim 16 in which the retrieved hash is compared to a calculation of the hash of the retrieved message, and only outputting the retrieved message if the respective hashes have the same value.

18. The methods of claim 2 in which the modulo polynomial, F(x), is a circulant polynomial.

19. A system comprising at least one processor configured to encrypt a digital message, by:
(a) generating a private key polynomial having coefficients from a first sub-set of predefined Galois field elements;
(b) constructing an inverse private key polynomial having coefficients which are an inverse of said private key polynomial where the polynomial product of the private key polynomial and the inverse private key polynomial modulo a third polynomial F(x) is equal to 1;
(c) generating a polynomial B(x) having coefficients from a second sub-set of said Galois field elements;
(d) constructing a public key polynomial by multiplying the inverse private key polynomial by the polynomial B(x) modulo F(x);
(e) representing the digital message as a polynomial M(x) having coefficients from a third sub-set of said Galois field elements;
(f) generating a session key polynomial S(x) having coefficients from a fourth sub-set of said Galois field elements; and
(g) generating an encrypted message by multiplying the session key polynomial S(x) by the public key polynomial, modulo F(x), and adding the result to the message polynomial M(x) to produce a polynomial representation of a cipher text.

20. A system comprising at least one processor configured to encrypt a digital message, by:
(a) generating a private key polynomial having coefficients from a first sub-set of predefined Galois field elements;
(b) constructing an inverse private key polynomial having coefficients which are an inverse of said private key polynomial where the polynomial product of the private key polynomial and the inverse private key polynomial modulo a third polynomial F(x) is equal to 1
(c) generating a polynomial B₁(x) having coefficients from a second sub-set of said Galois field elements;
(d) generating a polynomial B₂(x) having coefficients from a third sub-set of said Galois field elements;
(e) generating a polynomial R₁(x) having coefficients from a fourth sub-set of said Galois field elements;
(f) generating a polynomial R₂(x) having coefficients from a fifth sub-set of said Galois field elements;
(g) constructing a public key polynomial by multiplying the inverse private key polynomial by the sum of the polynomial B₁(x) and R₁(x), modulo F(x), and then adding the polynomials B₂(x) and R₂(x);
(h) representing the digital message as a polynomial M(x) having coefficients from a sixth sub-set of said Galois field elements;
(i) generating a session key polynomial S(x) having coefficients from a seventh sub-set of said Galois field elements; and
(j) generating an encrypted message by multiplying the session key polynomial S(x) by the public key polynomial, modulo a polynomial F(x), and adding the result to the message polynomial M(x) to produce a polynomial representation of a cipher text.

21. A non-transitory computer-readable medium comprising computer-executable instructions stored thereon, that when executed perform the method of claim 1.

22. A non-transitory computer-readable medium comprising computer-executable instructions stored thereon, that when executed perform the method of claim 2.
